(19) United States
(12) Patent Application Publication
(10) Pub. No.: US 2026/0307421 A1
(43) Pub. Date: Oct. 8, 2026

(54) IDENTIFICATION ELEMENT, INQUIRY APPARATUS, AND INQUIRY METHOD

(71) Applicant: SONY GROUP CORPORATION, Tokyo (JP)

(72) Inventors: Takehisa ISHIDA, Kanagawa (JP); Aya TEJIMA, Kanagawa (JP); Yuki OISHI, Kanagawa (JP); Tomokazu HIKE, Kanagawa (JP); Fumiko SHIGA, Tokyo (JP)

(73) Assignee: SONY GROUP CORPORATION, Tokyo (JP)

(21) Appl. No.: 19/481,142

(22) PCT Filed: May 15, 2024
(86) PCT No.: PCT/JP2024/017888

§ 371 Date: Nov. 3, 2025

(30) Foreign Application Priority Data
Jun. 6, 2023 (JP) 2023-093386

(51) Int. Cl. B42D 25/30; B42D 25/36

(52) U.S. Cl. CPC B42D 25/30; B42D 25/36

(57) ABSTRACT

An identification element according to an aspect of the present disclosure includes a thermosensitive recording medium provided with one or a plurality of layers on a support substrate. An identification region having a unique physical feature is provided in at least a portion of the thermosensitive recording medium.

### TECHNICAL FIELD

The present disclosure relates to an identification element, an inquiry apparatuses, and an inquiry method.

### BACKGROUND ART

In recent years, technologies have been developed to improve an anti-counterfeit property of a card such as a security card, a financial payment card (e.g., a credit card, a cash card, etc.), an ID card (e.g., a passport, an entry/exit card, an employee ID card, a membership card, a student ID card, etc.), or an individual transaction card (e.g., a prepaid card, a point card, etc.). In addition, technologies have also been developed to improve safety of authentication in an authentication system using the above-mentioned card (see, e.g., PTL 1).

### CITATION LIST

### Patent Literature

PTL 1: International Publication No. WO2020/196376

### SUMMARY OF THE INVENTION

Incidentally, a card as described above is required to improve an anti-counterfeit property without impairing its appearance. In addition, it is required to improve safety of authentication in a simple manner. It is desirable to provide an identification element that makes it possible to improve an anti-counterfeit property without impairing appearance. In addition, it is desirable to provide an inquiry apparatus and an inquiry method that make it possible to improve safety of authentication in a simple manner.

An identification element according to an aspect of the present disclosure includes a thermosensitive recording medium provided with one or a plurality of layers on a support substrate. An identification region having a unique physical feature is provided in at least a portion of the thermosensitive recording medium.

An inquiry apparatus according to an aspect of the present disclosure includes a detector and a signal processing unit. The detector is configured to detect, from an identification region of a recording medium including the identification region having a unique physical feature, information based on the unique physical feature that allows for identification of the recording medium, or feature information corresponding to the information. The signal processing unit is configured to inquire of an information processing apparatus about the information obtained by the detector, and is configured to acquire an inquiry result from the information processing apparatus.

An inquiry method according to an aspect of the present disclosure includes the following two steps:
(A) detecting, from an identification region of a recording medium including the identification region having a unique physical feature, information based on the unique physical feature that allows for identification of the recording medium, or feature information corresponding to the information; and
(B) inquiring of an information processing apparatus about the information obtained by the detection to acquire an inquiry result from the information processing apparatus.

### BRIEF DESCRIPTION OF THE DRAWINGS

FIG. 1 is a diagram illustrating an example of a perspective configuration of an identification element according to a first embodiment of the present disclosure.

FIG. 2 is a diagram illustrating an example of a cross-sectional configuration of the identification element of FIG. 1.

FIG. 3 is a diagram illustrating an example of a cross-sectional configuration of an identification layer of FIG. 2.

FIG. 4 is a diagram illustrating an example of a cross-sectional configuration of a thermosensitive recording layer of FIG. 2.

FIG. 5 is a diagram illustrating an example of a cross-sectional configuration of the identification element before drawing.

FIG. 6 is a diagram illustrating an example of a state where drawing is performed on the identification element of FIG. 5.

FIG. 7 is a diagram illustrating an example of a schematic configuration of an authentication system that authenticates the identification element of FIG. 1.

FIG. 8 is a diagram illustrating an example of functional blocks of a collation apparatus of FIG. 7.

FIG. 9 is a diagram illustrating an example of functional blocks of the collation apparatus of FIG. 7.

FIG. 10 is a diagram illustrating an example of functional blocks of a registration apparatus of FIG. 7.

FIG. 11 is a diagram illustrating an example of functional blocks of an inquiry/registration apparatus of FIG. 7.

FIG. 12 is a diagram illustrating an example of functional blocks of a drawing apparatus of FIG. 7.

FIG. 13 is a diagram illustrating an example of functional blocks of an inquiry apparatus of FIG. 7.

FIG. 14 is a diagram illustrating an example of a procedure for registering individual identification information and serial numbers in the authentication system of FIG. 7.

FIG. 15 is a diagram illustrating an example of a procedure for collating the individual identification information in the authentication system of FIG. 7 and a procedure for registering meta information and serial numbers.

FIG. 16 is a diagram illustrating an example of a procedure for collating individual identification information and a procedure for collating serial numbers in the authentication system of FIG. 7.

FIG. 17 is a diagram illustrating a modification example of the schematic configuration of the authentication system of FIG. 7.

FIG. 18 is a diagram illustrating an example of functional blocks of a collation apparatus of FIG. 17.

FIG. 19 is a diagram illustrating an example of a procedure for registering individual identification information and meta information in the authentication system of FIG. 17.

FIG. 20 is a diagram illustrating an example of a procedure for collating individual identification information in the authentication system of FIG. 17.

FIG. 21 is a diagram illustrating a modification example of the perspective configuration of the identification element of FIG. 1.

FIG. 22 is a diagram illustrating a modification example of the perspective configuration of the identification element of FIG. 1.

FIG. 23 is a diagram illustrating an example of a cross-sectional configuration of the identification element of FIG. 22.

FIG. 24 is a diagram illustrating a modification example of the cross-sectional configuration of the identification element of FIG. 22.

FIG. 25 is a diagram illustrating an example of a perspective configuration of an identification element according to a second embodiment of the present disclosure.

FIG. 26 is a diagram illustrating an example of a cross-sectional configuration of the identification element of FIG. 25.

FIG. 27 is a diagram illustrating an example of a cross-sectional configuration of a thermosensitive recording layer of FIG. 26.

FIG. 28 is a diagram illustrating an example of a cross-sectional configuration of an identification element before drawing.

FIG. 29 is a diagram illustrating an example of a state where drawing is performed on the identification element of FIG. 28.

FIG. 30 is a diagram illustrating an example of manufacturing the identification element according to the modification example.

FIG. 31 is a diagram illustrating a modification example of the cross-sectional configuration of the thermosensitive recording layer of FIG. 26.

FIG. 32 is a diagram illustrating a modification example of the perspective configuration of the identification element of FIG. 25.

FIG. 33 is a diagram illustrating an example of a cross-sectional configuration of the identification element of FIG. 32.

FIG. 34 is a diagram illustrating an example of a planar configuration of a portion of the identification element of FIG. 32.

FIG. 35 is a diagram illustrating a modification example of the perspective configuration of the identification element of FIG. 25.

FIG. 36 is a diagram illustrating an example of a cross-sectional configuration of the identification element of FIG. 35.

FIG. 37 is a diagram illustrating an example of a planar configuration of a portion of the identification element of FIG. 35.

FIG. 38 is a diagram illustrating a modification example of the planar configuration of a portion of the identification element of FIG. 35.

FIG. 39 is a diagram illustrating a modification example of the perspective configuration of the identification element of FIG. 25.

FIG. 40 is a diagram illustrating an example of a cross-sectional configuration of the identification element of FIG. 39.

FIG. 41 is a diagram illustrating a modification example of the perspective configuration of the identification element of FIG. 32.

FIG. 42 is a diagram illustrating an example of a cross-sectional configuration of the identification element of FIG. 41.

FIG. 43 is a diagram illustrating a modification example of the cross-sectional configuration of the identification element of FIG. 41.

FIG. 44 is a diagram illustrating a modification example of the cross-sectional configuration of the thermosensitive recording layer provided in the identification element according to each of the second embodiment of the present disclosure and the modification example thereof.

FIG. 45 is a diagram illustrating a modification example of the cross-sectional configuration of the thermosensitive recording layer provided in the identification element according to each of the second embodiment of the present disclosure and the modification example thereof.

### MODES FOR CARRYING OUT THE INVENTION

Hereinafter, description is given in detail of modes for carrying out the present disclosure with reference to the drawings. The following description is a specific example of the present disclosure, and the present disclosure is not limited to the following aspects.

### 1. First Embodiment

### [Configuration]

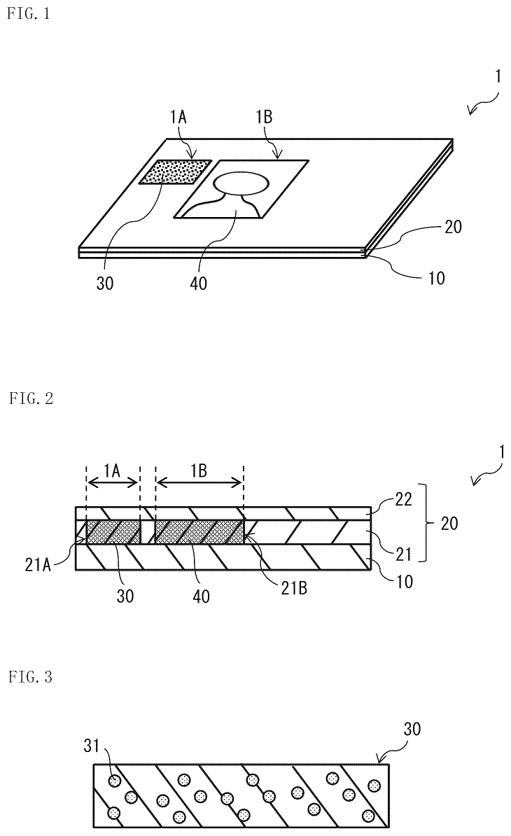

Description is given of an identification element 1 according to a first embodiment of the present disclosure. FIG. 1 illustrates an example of a perspective configuration of the identification element 1 according to the present embodiment. FIG. 2 illustrates an example of a cross-sectional configuration of the identification element 1 of FIG. 1. The identification element 1 is, for example, a recording medium suitably usable for a card such as a security card, a financial payment card (e.g., a credit card, a cash card, etc.), an ID card (e.g., a passport, an entry/exit card, an employee ID card, a membership card, a student ID card, etc.), or an individual transaction card (e.g., a prepaid card, a point card, etc.).

The identification element 1 includes a thermosensitive recording medium 20 provided with one or a plurality of layers on a support substrate 10, for example as illustrated in FIGS. 1 and 2. The thermosensitive recording medium 20 is a plate-like recording medium having an identification region 1A and a thermosensitive recording region 1B. An identification layer 30 is disposed in the identification region 1A, and a thermosensitive recording layer 40 is disposed in the thermosensitive recording region 1B. The identification region 1A (identification layer 30) is disposed, on the support substrate 10, at a location different from the thermosensitive recording region 1B (thermosensitive recording layer 40), in a plan view. The identification region 1A (identification layer 30) is disposed, on the support substrate 10, at a location different from the thermosensitive recording region 1B (thermosensitive recording layer 40), in a side view.

The thermosensitive recording medium 20 includes, for example, an embedded layer 21 in contact with a surface of the support substrate 10, and a cover layer 22 that is in contact with a surface of the embedded layer 21 and covers the embedded layer 21. The cover layer 22 constitutes an outermost surface of the identification element 1 (thermosensitive recording medium 20). The identification layer 30 and the thermosensitive recording layer 40 are covered with the support substrate 10, the embedded layer 21, and the cover layer 22.

The support substrate 10 is a support that supports the thermosensitive recording medium 20. The support substrate 10 may have a color such as white. A design, a graphic, a photograph, a letter, or a combination of two or more thereof (hereinafter, referred to as “a design, or the like”) may be printed on a surface, of the support substrate 10, on a side provided with the thermosensitive recording medium 20.

The support substrate 10 includes plastic, for example. The support substrate 10 may include, as needed, at least one selected from the group consisting of a colorant, an antistatic agent, a flame retardant, a surface modifier, and the like. A reflective layer (unillustrated) may be provided on at least one main surface of the support substrate 10, and the support substrate 10 itself may also function as a reflective layer.

The plastic for use in the support substrate 10 includes, for example, at least one selected from the group consisting of an ester-based resin, an amide-based resin, an olefin-based resin, a vinyl-based resin, an acrylic-based resin, an imide-based resin, a styrene-based resin, engineering plastic, and the like. In a case where the support substrate 10 includes two or more resins, the two or more resins may be mixed, copolymerized, or stacked.

The above-mentioned ester-based resin includes, for example, at least one selected from the group consisting of polyethylene terephthalate (PET), polybutylene terephthalate (PBT), polyethylene naphthalate (PEN), a polyethylene terephthalate-isophthalate copolymer, a terephthalic acid-cyclohexanedimethanol-ethylene glycol copolymer, and the like. The above-described amide-based resin includes, for example, at least one selected from the group consisting of nylon 6, nylon 66, nylon 610, and the like. The above-described olefin-based resin includes, for example, at least one selected from the group consisting of polyethylene (PE), polypropylene (PP), polymethylpentene (PMP), and the like. The above-described vinyl-based resin includes, for example, polyvinyl chloride (PVC).

The above-described acrylic-based resin includes, for example, at least one selected from the group consisting of polyacrylate, polymethacrylate, polymethyl methacrylate (PMMA), and the like. The above-described imide-based resin includes, for example, at least one selected from the group consisting of polyimide (PI), polyamideimide (PAI), polyetherimide (PEI), and the like. The above-described styrene-based resin includes, for example, at least one selected from the group consisting of polystyrene (PS), high impact polystyrene, an acrylonitrile-styrene resin (AS resin), an acrylonitrile-butadiene-styrene resin (ABS resin), and the like. The above-described engineering plastic includes, for example, at least one selected from the group consisting of polycarbonate (PC), polyarylate (PAR), polysulfone (PSF), polyether sulfone (PES), polyphenylene ether (PPE), polyphenylene sulfide (PPS), polyether ketone (PEK), polyether-ether ketone (PEEK), polyphenylene oxide (PPO), polyether sulfite, and the like.

The embedded layer 21 is provided on one main surface of the support substrate 10. The embedded layer 21 is adapted to suppress a step difference formed by the identification layer 30 and the thermosensitive recording layer 40 at the time when the identification layer 30 and the thermosensitive recording layer 40 are sandwiched between the support substrate 10 and the cover layer 22. The embedded layer 21 has a thickness substantially the same as that of the thickest layer of the identification layer 30 and the thermosensitive recording layer 40, for example, and covers a region, of one main surface of the support substrate 10, other than those where the identification layer 30 and the thermosensitive recording layer 40 are provided.

The embedded layer 21 has an embedding structure enabling the identification layers 30 and thermosensitive recording layer 40 to be embedded. The embedded layer 21 is provided with, for example, a through-hole part 21A that is able to embed the identification layer 30 and a through-hole part 21B that is able to embed the thermosensitive recording layer 40. The through-hole part 21A penetrates the embedded layer 21, and the identification layer 30 is fitted into the through-hole part 21A. The through-hole part 21B penetrates the embedded layer 21, and the thermosensitive recording layer 40 is fitted into the through-hole part 21B.

It is to be noted that the identification layer 30 and the thermosensitive recording layer 40 may have the same thickness as each other, or may have different thicknesses from each other. In a case where the thickness of the identification layer 30 is thinner than that of the embedded layer 21, a recess may be provided, instead of the through-hole part 21A, on a surface of the embedded layer 21 on a side of the support substrate 10 or on a surface of the embedded layer 21 on a side of the cover layer 22; the identification layer 30 may be fitted into the recess. In addition, in a case where the thickness of the thermosensitive recording layer 40 is thinner than that of the embedded layer 21, a recess may be provided, instead of the through-hole part 21B, on a surface of the embedded layer 21 on the side of the support substrate 10 or on a surface of the embedded layer 21 on the side of the cover layer 22; the thermosensitive recording layer 40 may be fitted into the recess.

The embedded layer 21 has a film shape, for example. The embedded layer 21 may have transparency to visible light. The embedded layer 21 includes plastic. Examples of the plastic for use in the embedded layer 21 may include a material similar to those of the support substrate 10. A design or the like may be printed on at least one main surface of the embedded layer 21.

The cover layer 22 is provided on the embedded layer 21, the identification layer 30, and the thermosensitive recording layer 40, and covers the embedded layer 21, the identification layer 30, and the thermosensitive recording layer 40. The cover layer 22 protects the identification layer 30 and the thermosensitive recording layer 40, and retains mechanical reliability of the identification layer 30 and the thermosensitive recording layer 40.

The cover layer 22 has a film shape, for example. The cover layer 22 may have transparency to visible light. The cover layer 22 includes plastic. Examples of the plastic for use in the cover layer 22 may include a material similar to those of the support substrate 10. A design or the like may be printed on at least one main surface of the cover layer 22.

Next, description is given of the identification region 1A (identification layer 30).

The identification region 1A (identification layer 30) is an identification region having a unique physical feature. The unique physical feature refers to a physical feature based on artifact metrics. The artifact metrics is a technique that verifies authenticity using unique feature information of an artifact and makes it difficult to create a copy of the artifact. The feature information is, for example, formed spontaneously at the time of manufacture of the artifact, and is difficult to form artificially. Examples of a method of verifying authenticity include a method of extracting feature information formed in an artifact using an imaging apparatus or the like to compare the extracted feature information and already registered feature information with each other.

The identification region 1A (identification layer 30) is, for example, a region in which retroreflective particles, phosphor particles, birefringent particles, infrared-absorbing particles, ultraviolet-absorbing particles, visible light-absorbing particles, or light-scattering particles are distributed. The identification layer 30 is a layer in which a plurality of particles 31 is dispersed in a resin binder, for example, as illustrated in FIG. 3. The identification layer 30 may be formed by, for example, printing an ink containing the plurality of particles 31 on the support substrate 10. Examples of the particle 31 may include a retroreflective particle, a phosphor particle, a birefringent particle, an infrared-absorbing particle, an ultraviolet-absorbing particle, a visible light-absorbing particle, or a light-scattering particle.

The retroreflective particle is a particle that has high directivity of diffuse reflection in a direction of incidence of outside light upon the incidence. For example, when outside light is reflected by a layer in which retroreflective particles are dispersed, the light (reflected light) is detected by an imaging apparatus, and resulting image data or data resulting from processing of the image data serves as the feature information described above. For example, a glass bead, which is one type of the retroreflective particle, is a particle that refracts and scatters outside light upon incidence thereof. The glass bead is formed by, for example, a glass material. For example, when outside light is refracted and scattered by a layer in which glass beads are dispersed, the light (refracted light and scattered light) is detected by an imaging apparatus, and resulting image data or data resulting from processing of the image data serves as the feature information described above.

A phosphor particle is a particle that absorbs optical energy of a specific wavelength included in outside light upon incidence thereof and emits the energy as light of a wavelength longer than a wavelength of the absorbed light. The phosphor particle is formed by, for example, an inorganic phosphor material. For example, outside light is absorbed by a layer in which phosphor particles are dispersed, and light (phosphor light) emitted accordingly is detected by an imaging apparatus; resulting image data or data resulting from processing of the image data serves as the feature information described above.

The birefringent particle is a particle that changes a polarization state of polarized light when being transmitted. The birefringent particle is formed by, for example, a birefringent material. For example, when outside light is transmitted through a layer in which birefringent particles are dispersed, via a polarizing plate, and when the light is reflected by the support substrate 10 or a reflective layer formed on a surface of the support substrate 10, the light (reflected light) is detected by an imaging apparatus via the polarizing plate, and resulting image data or data resulting from processing of the image data serves as the feature information described above.

The infrared-absorbing particle is a particle that absorbs optical energy of a wavelength in an infrared region included in outside light upon incidence thereof. The infrared-absorbing particle is formed by, for example, a material that absorbs optical energy of a wavelength in the infrared region. For example, when outside light is transmitted through a layer in which infrared-absorbing particles are dispersed, and when the light is reflected by the support substrate 10 or a reflective layer formed on a surface of the support substrate 10, the light (reflected light) is detected by an imaging apparatus, and resulting image data or data resulting from processing of the image data serves as the feature information described above.

The ultraviolet-absorbing particle is a particle that absorbs optical energy of a wavelength in an ultraviolet region included in outside light upon incidence thereof. The ultraviolet-absorbing particle is formed by, for example, a material that absorbs the optical energy of the wavelength in the ultraviolet region. For example, when outside light is transmitted through a layer in which ultraviolet-absorbing particles are dispersed, and when the light is reflected by the support substrate 10 or a reflective layer formed on a surface of the support substrate 10, the light (reflected light) is detected by an imaging apparatus, and resulting image data or data resulting from processing of the image data serves as the feature information described above.

The visible light-absorbing particle is a particle that absorbs optical energy of a wavelength in a visible light region included in outside light upon incidence thereof. The visible light-absorbing particle is formed by, for example, a material that absorbs the optical energy of the wavelength in the visible light region. For example, when outside light is transmitted through a layer in which visible light-absorbing particles are dispersed, and when the light is reflected by the support substrate 10 or a reflective layer formed on a surface of the support substrate 10, the light (reflected light) is detected by an imaging apparatus, and resulting image data or data resulting from processing of the image data serves as the feature information described above.

The light-scattering particle is a particle that scatters outside light upon incidence thereof. The light-scattering particle is formed by, for example, a material that scatters outside light. For example, when outside light is scattered by a layer in which light-scattering particles are dispersed, and when the light (scattered light) is reflected by the support substrate 10 or a reflective layer formed on a surface of the support substrate 10, the light (reflected light) is detected by an imaging apparatus, and resulting image data or data resulting from processing of the image data serves as the feature information described above.

Next, description is given of the thermosensitive recording region 1B (thermosensitive recording layer 40).

Meta information on a user of the identification element 1 may be embedded in the thermosensitive recording region 1B (thermosensitive recording layer 40). The user of the identification element 1 is a person who uses the identification element 1 for his or her own identification or a person who is authorized to use a service associated with the identification element 1. In a case where the identification element 1 is an ID card (e.g., a passport, an entry/exit card, an employee ID card, a membership card, a student ID card, etc.), or a security card, the user of the identification element 1 refers to a person recorded in the ID card or in the security card. In a case where the identification element 1 is an individual transaction card (e.g., a prepaid card, a point card, etc.), the user of the identification element 1 refers to a person recorded in the individual transaction card as a person authorized to use a service (e.g., electronic money, points, etc.) associated with the individual transaction card. In a case where the identification element 1 is a financial payment card (e.g., a credit card, a cash card, etc.), the user of the identification element 1 refers to a person recorded in the financial payment card as a person authorized to use a service (e.g., payment, etc.) associated with the financial payment card.

The meta information on the user is information that enables identification of an individual user, and includes, for example, image information (e.g., face photo) and text information (e.g., date of birth, address, and nationality) on the user. The image information included in the meta information is embedded in the thermosensitive recording region 1B (thermosensitive recording layer 40).

The thermosensitive recording layer 40 is configured to be able to change the state of coloring by an external stimulus. The change in the state of coloring enables design or the like, for example, to be recorded in the thermosensitive recording layer 40. The external stimulus is specifically laser light irradiation. The change in the state of coloring is preferably an irreversible change from the viewpoint of an improvement in an anti-counterfeit property. That is, a method for the thermosensitive recording layer 40 is preferably a write-once method that enables design or the like to be written only once. The thermosensitive recording layer 40 is, for example, a sheet-like or plate-like recording medium having a quadrate shape, in a plan view.

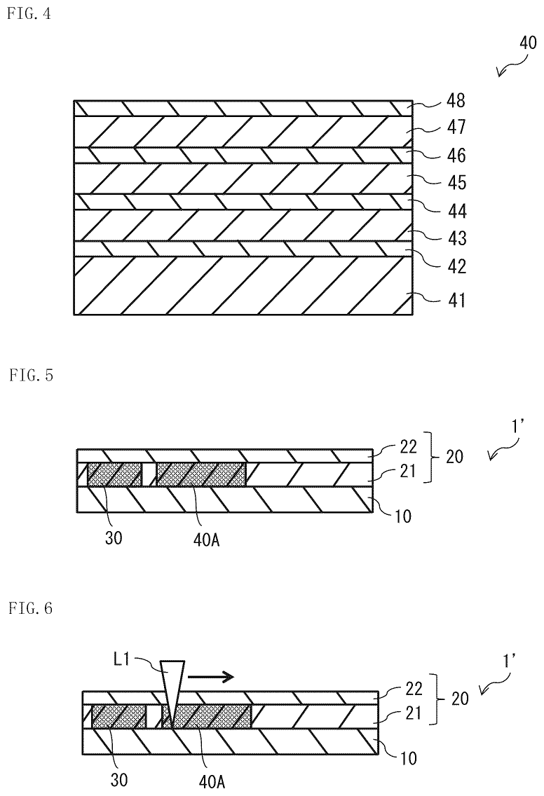

The thermosensitive recording layer 40 includes, for example, a base material 41, an underlayer 42, a recording layer 43, an intermediate layer 44, a recording layer 45, an intermediate layer 46, and a recording layer 47, in this order, as illustrated in FIG. 4. For example, as illustrated in FIG. 4, a protective layer 48 may be provided on an outermost surface of the thermosensitive recording layer 40; alternatively, the outermost surface of the thermosensitive recording layer 40 may be the recording layer 47. In the thermosensitive recording layer 40, one or two recording layers among the recording layers 43, 45, and 47 may be omitted, as needed. The thermosensitive recording layer 40 is disposed in the through-hole part 21B to allow, for example, the base material 41 to be closer to the support substrate 10. In a case where the protective layer 48 functions as a base material of the thermosensitive recording layer 40, i.e., in a case where the protective layer 48 is able to support the recording layer 43, the intermediate layer 44, the recording layer 45, the intermediate layer 46, and the recording layer 47, the base material 41 and the underlayer 42 may be omitted. At this time, it is possible, in a process of manufacturing the identification element 1, to bring a surface of the recording layer 43 into contact with the surface of the support substrate 10 to thermally fuse the recording layer 43 and the support substrate 10 together.

The base material 41 is a support to support the recording layers 43, 45, and 47, and the like. The base material 41 is preferably configured by a material having superior heat resistance and superior dimensional stability in a plane direction. The base material 41 may have characteristics of either light transmissivity or non-light transmissivity to visible light. In a case where it is difficult for the base material 41 to transmit visible light, for example, the color of a surface of the base material 41 may be white, or may be a color other than white.

The base material 41 may be, for example, a highly rigid substrate such as a wafer, or may be a flexible thin-layer glass, film, or paper. Using a flexible substrate as the base material 41 enables achievement of a flexible (foldable) thermosensitive recording layer 40. Examples of a constituent material of the base material 41 include an inorganic material, a metal material, and plastic. The inorganic material includes, for example, at least one selected from the group consisting of silicon (Si), silicon oxide (SiOₓ), silicon nitride (SiNₓ), aluminum oxide (AlOₓ), and the like. The silicon oxide includes glass, spin-on-glass (SOG), and the like. The metal material includes, for example, at least one selected from the group consisting of aluminum (Al), nickel (Ni), stainless steel, and the like.

The base material 41 may include plastic, for example. The base material 41 may include, as needed, at least one selected from the group consisting of a colorant, an antistatic agent, a flame retardant, a surface modifier, and the like.

The plastic for use in the base material 41 includes, for example, at least one selected from the group consisting of an ester-based resin, an amide-based resin, an olefin-based resin, a vinyl-based resin, an acrylic-based resin, an imide-based resin, a styrene-based resin, engineering plastic, and the like. In a case where the base material 41 includes two or more resins, the two or more resins may be mixed, copolymerized, or stacked.

The above-described ester-based resin includes, for example, at least one selected from the group consisting of polyethylene terephthalate (PET), polybutylene terephthalate (PBT), polyethylene naphthalate (PEN), polyethylene terephthalate-isophthalate copolymer, a terephthalic acid-cyclohexanedimethanol-ethylene glycol copolymer, and the like. The amide-based resin includes, for example, at least one selected from the group consisting of nylon 6, nylon 66, nylon 610, and the like. The above-described olefin-based resin includes, for example, at least one selected from the group consisting of polyethylene (PE), polypropylene (PP), polymethylpentene (PMP), and the like. The above-described vinyl-based resin includes polyvinyl chloride (PVC), for example.

The above-described acrylic-based resin includes, for example, at least one selected from the group consisting of polyacrylate, polymethacrylate, polymethyl methacrylate (PMMA), and the like. The imide-based resin includes, for example, at least one selected from the group consisting of polyimide (PI), polyamideimide (PAI), polyetherimide (PEI), and the like. The above-described styrene-based resin includes, for example, at least one selected from the group consisting of polystyrene (PS), high impact polystyrene, an acrylonitrile-styrene resin (AS resin), an acrylonitrile-butadiene-styrene resin (ABS resin), and the like. The above-described engineering plastic includes, for example, at least one selected from the group consisting of polycarbonate (PC), polyarylate (PAR), polysulfone (PSF), polyether sulfone (PES), polyphenylene ether (PPE), polyphenylene sulfide (PPS), polyether ketone (PEK), polyether-ether ketone (PEEK), polyphenylene oxide (PPO), polyether sulfite, and the like.

The underlayer 42 has a function of improving adhesiveness between the recording layer 43 and the base material 41. The underlayer 42 is configured by, for example, a material that transmits visible light. It is to be noted that a moisture-resistant barrier layer or a light-resistant barrier layer may be provided above or below the underlayer 42 or the base material 41. In addition, a heat-insulating layer may be provided between the underlayer 42 and the recording layer 43. A reflective layer (unillustrated) may be provided on at least one main surface of the base material 41; alternatively, the base material 41 itself may also function as a reflective layer. The base material 41 having such a configuration enables more vivid color display.

It is possible for the recording layers 43, 45, and 47 to reversibly change a state between a colored state and a decolored state. The recording layers 43, 45, and 47 are configured to allow colors in the colored state to differ from each other. Each of the recording layers 43, 45, and 47 is a thermosensitive recording layer including a color-forming compound, a photothermal converting agent, and a color-developing/reducing agent. The recording layers 43, 45, and 47 include color-forming compounds having different colors in the colored state and photothermal converting agents having different light-absorbing wavelength ranges. In the recording layers 43, 45, and 47, the color-forming compound, the photothermal converting agent, and the color-developing/reducing agent are dispersed in a matrix resin (macromolecular material). Each of the recording layers 43, 45, and 47 may be a stack in which a layer including the color-forming compound and the color-developing/reducing agent and a layer including the photothermal converting agent are stacked, or may have a single-layer structure including the color-forming compound, the photothermal converting agent, and the color-developing/reducing agent.

For example, a leuco dye is used as the color-forming compound. The leuco dye is coupled, by heat, to the color-developing/reducing agent to be brought into the colored state, or is separated from the color-developing/reducing agent to be brought into the decolored state. The color tones of respective leuco dyes included in the recording layers 43, 45, and 47 differ for the respective recording layers 43, 45, and 47. The leuco dye included in the recording layer 43 is bonded, by heat, to the color-developing/reducing agent to be colored in magenta. The leuco dye included in the recording layer 45 is bonded, by heat, to the color-developing/reducing agent to be colored in cyan. The leuco dye included in the recording layer 47 is bonded, by heat, to the color-developing/reducing agent to be colored in yellow. The positional relationship among the recording layers 43, 45, and 47 is not limited to the above-described example. In addition, the recording layers 43, 45, and 47 each become transparent in the decolored state. This enables the thermosensitive recording layer 40 to record an image using colors in a wide color gamut.

Examples of the leuco dye include an existing dye for thermosensitive paper. Specific examples of the leuco dye include a compound containing, in a molecule, a group having an electronic-donating property, for example, represented by the following Chem. 1.

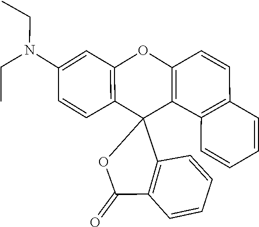 [SMILES: CCN(CC)c1ccc2c(c1)Oc1ccc3ccccc3c1C21OC(=O)c2ccccc21]

The above-described color-forming compound is not particularly limited, and may be appropriately selected depending on objectives. Specific examples of the color-forming compound include, in addition to the compound represented by the above formula (1), a fluorane-based compound, a triphenylmethanephthalide-based compound, an azaphthalide-based compound, a phenothiazine-based compound, a leucolamine-based compound, and an indolinophthalide-based compound. Other examples thereof include 2-anilino-3-methyl-6-diethylaminofluoran, 2-anilino-3-methyl-6-di(n-butylamino)fluoran, 2-anilino-3-methyl-6-(N-n-propyl-N-methylamino)fluoran, 2-anilino-3-methyl-6-(N-isopropyl-N-methylamino)fluoran, 2-anilino-3-methyl-6-(N-isobutyl-N-methylamino)fluoran, 2-anilino-3-methyl-6-(N-n-amyl-N-methyamino)fluoran, 2-anilino-3-methyl-6-(N-sec-butyl-N-methyamino)fluoran, 2-anilino-3-methyl-6-(N-n-amyl-N-ethylamino)fluoran, 2-anilino-3-methyl-6-(N-iso-amyl-N-ethylamino)fluoran, 2-anilino-3-methyl-6-(N-n-propyl-N-isopropylamino)fluoran, 2-anilino-3-methyl-6-(-N-cyclohexyl-N-methylamino)fluoran, 2-anilino-3-methyl-6-(N-ethyl-p-toluidino)fluoran, 2-anilino-3-methyl-6-(-N-methyl-p-toluidino)fluoran, 2-(m-trichloromethylanilino)-3-methyl-6-diethylaminofluoran, 2-(m-trifluoromethylanilino)-3-methyl-6-diethylaminofluoran, 2-(m-trichloromethylanilino)-3-methyl-6-(N-cyclohexyl-N-methylamino)fluoran, 2-(2,4-dimethylanilino)-3-methyl-6-diethylaminofluoran, 2-(N-ethyl-p-toluidino)-3-methyl-6-(N-ethylanilino)fluoran, 2-(N-ethyl-p-toluidino)-3-methyl-6-(N-propyl-p-toluidino)fluoran, 2-anilino-6-(N-n-hexyl-N-ethylamino)fluoran, 2-(o-chloroanilino)-6-diethylaminofluoran, 2-(o-chloroanilino)-6-dibutylaminofluoran, 2-(m-trifluoromethylanilino)-6-diethylaminofluoran, 2,3-dimethyl-6-dimethlylaminofluoran, 3-methyl-6-(N-ethyl-p-toluidino)fluoran, 2-chloro-6-diethylaminofluoran, 2-bromo-6-diethylaminofluoran, 2-chloro-6-dipropylaminofluoran, 3-chloro-6 cyclohexylaminofluoran, 3-bromo-6-cyclohexylaminofluoran, 2-chloro-6-(N-ethyl-N-isoamylamino)fluoran, 2-chloro-3-methyl-6-diethylaminofluoran, 2-anilino-3-chloro-6-diethylaminofluoran, 2-(o-chloroanilino)-3-chloro-6-cyclohexylaminofluoran, 2-(m-trifluoromethylanilino)-3-chloro-6-diethylaminofluoran, 2-(2,3-dichloroanilino)-3-chloro-6-diethylaminofluoran, 1,2-benzo-6-diethylaminofluoran, 3-diethylamino-6-(m-trifluoromethylanilino)fluoran, 3-(1-ethyl-2-methylindol-3-yl)-3-(2-ethoxy-4-diethylaminophenyl)-4-azapthalide, 3-(1-ethyl-2-methylindol-3-yl)-3-(2-ethoxy-4-diethylaminophenyl)-7-azapthalide, 3-(1-octyl-2-methylindol-3-yl)-3-(2-ethoxy-4-diethylaminophenyl)-4-azaphthalide, 3-(1-ethyl-2-methylindol-3-yl)-3-(2-methyl-4-diethylaminophenyl)-7-azaphthalide, 3-(1-ethyl-2-methylindol-3-yl)-3-(2-methyl-4-diethylaminophenyl)-7-azaphthalide, 3-(1-ethyl-2-methylindol-3-yl)-3-(4-diethylaminophenyl)-4-azaphthalide, 3-(1-ethyl-2-methylindol-3-yl)-3-(4-N-n-amyl-N-methylaminophenyl)-4-azaphthalide, 3-(1-methyl-2-methylindol-3-yl)-3-(2-hexyloxy-4-diethylaminophenyl)-4-azaphthalide, 3,3-bis(2-ethoxy-4-diethylaminophenyl)-4-azaphthalide, 3,3-bis(2-ethoxy-4-diethylaminophenyl)-7-azaphthalide, 2-(p-acetylanilino)-6-(N-n-amyl-N-n-butylamino)fluoran, 2-benzylamino-6-(N-ethyl-p-toluidino)fluoran, 2-benzylamino-6-(N-methyl-2,4-dimethylanilino)fluoran, 2-benzylamino-6-(N-ethyl-2,4-dimethylanilino)fluoran, 2-benzylamino-6-(N-methyl-p-toluidino)fluoran, 2-benzylamino-6-(N-ethyl-p-toluidino)fluoran, 2-(di-p-methylbenzylamino)-6-(N-ethyl-p-toluidino)fluoran, 2-(α-phenylethylamino)-6-(N-ethyl-p-toluidino)fluoran, 2-methylamino-6-(N-methylanilino)fluoran, 2-methylamino-6-(N-ethylanilino)fluoran, 2-methylamino-6-(N-propylanilino)fluoran, 2-ethylamino-6-(N-methyl-p-toluidino)fluoran, 2-methylamino-6-(N-methyl-2,4-dimethylanilino)fluoran, 2-ethylamino-6-(N-ethyl-2,4-dimethylanilino)fluoran, 2-dimethylamino-6-(N-methylanilino)fluoran, 2-dimethylamino-6-(N-ethylanilino)fluoran, 2-diethylamino-6-(N-methyl-p-toluidino)fluoran, 2-diethylamino-6-(N-ethyl-p-toluidino)fluoran, 2-dipropylamino-6-(N-methylanilino)fluoran, 2-dipropylamino-6-(N-ethylanilino)fluoran, 2-amino-6-(N-methylanilino)fluoran, 2-amino-6-(N-ethylanilino)fluoran, 2-amino-6-(N-propylanilino)fluoran, 2-amino-6-(N-methyl-p-toluidino)fluoran, 2-amino-6-(N-ethyl-p-toluidino)fluoran, 2-amino-6-(N-propyl-p-toluidino)fluoran, 2-amino-6-(N-methyl-p-ethylanilino)fluoran, 2-amino-6-(N-ethyl-p-ethylanilino)fluoran, 2-amino-6-(N-propyl-p-ethylanilino)fluoran, 2-amino-6-(N-methyl-2,4-dimethylanilino)fluoran, 2-amino-6-(N-ethyl-2,4-dimethylanilino)fluoran, 2-amino-6-(N-propyl-2,4-dimethylanilino)fluoran, 2-amino-6-(N-methyl-p-chloroanilino)fluoran, 2-amino-6-(N-ethyl-p-chloroanilino)fluoran, 2-amino-6-(N-propyl-p-chloroanilino)fluoran, 1,2-benzo-6-(N-ethyl-N-isoamylamino)fluoran 1,2-benzo-6-dibutylaminofluoran, 1,2-benzo-6-(N-methyl-N-cyclohexylamino)fluoran, 1,2-benzo-6-(N-ethyl-N-toluidino)fluoran, and the like. Each of the recording layers 43, 45, and 47 may include one of the above-mentioned color-forming compounds alone, or may include two or more thereof.

The color-developing/reducing agent is adapted to color a colorless color-forming compound or to decolor a color-forming compound that exhibits a predetermined color, for example. Examples of the color-developing/reducing agent include a phenol derivative, a salicylic acid derivative, a urea derivative, and the like. Specifically, the color-developing/reducing agent may include, for example, a compound represented by the following Chem. 2.

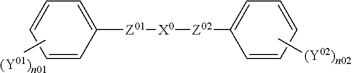

In the formula (2), X⁰ is a divalent group containing at least one benzene ring. In a case where X⁰ contains at least two benzene rings, the at least two benzene rings may be condensed. Y⁰¹ and Y⁰² are, independently of each other, a monovalent group. n01 and n02 are, independently of each other, an integer of any of 0 to 5. In a case where n01 is an integer of any of 2 to 5, Y⁰¹ may be the same as or different from each other. In a case where n02 is an integer of any of 2 to 5, Y⁰² may be the same as or different from each other. Z⁰¹ and Z⁰² are, independently of each other, a hydrogen-bonding group.

X⁰ containing at least one benzene ring enables a melting point to be higher than a case where X⁰ is an aliphatic hydrocarbon group (e.g., a normal alkyl chain), thus making it possible to improve coloration-retaining characteristics during high-temperature and high-humidity storage (hereinafter, referred to as “high-temperature high-humidity storage characteristics”). From the viewpoint of improvements in the high-temperature high-humidity storage characteristics and heat resistance, it is preferable for X⁰ to contain at least two benzene rings. The high-temperature high-humidity storage characteristics are, for example, storage characteristics in an environment of 80° C. and 60% RH. An improvement in heat resistance allows for an improvement in resistance of the recording medium 20 against a severe process (e.g., integral molding using a molten resin or hot press, etc.). In a case where X⁰ contains at least two benzene rings, the at least two benzene rings may be condensed. For example, naphthalene, anthracene, or the like may be adopted.

Z⁰¹ and Z⁰², which are, independently of each other, a hydrogen-bonding group, cause the color-developing agents to tend to be present in a solidified manner to some extent through hydrogen bonding, thus improving stability of the color-developing agent in the recording layers 43, 45, and 47. As used herein, the hydrogen-bonding group means a functional group containing atoms enabling hydrogen bonding with atoms present in another functional group, another compound, or the like.

The color-developing agent may include a compound represented by the following formula (3).

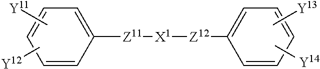

In the formula (3), X¹ is a divalent group containing at least one benzene ring. Y¹¹, Y¹², Y¹³, and Y¹⁴ are, independently of one another, a monovalent group. Z¹¹ and Z¹² are, independently of each other, a hydrogen-bonding group.

X¹ containing at least one benzene ring enables a melting point to be higher than a case where X¹ is an aliphatic hydrocarbon group (e.g., a normal alkyl chain), thus making it possible to improve high-temperature high-humidity storage characteristics. From the viewpoint of improvements in the high-temperature high-humidity storage characteristics and heat resistance, it is preferable for X¹ to contain at least two benzene rings. In a case where X¹ contains at least two benzene rings, the at least two benzene rings may be condensed. For example, naphthalene, anthracene, or the like may be adopted.

Z¹¹ and Z¹², which are, independently of each other, a hydrogen-bonding group, cause the color-developing agents to tend to be present in a solidified manner to some extent through hydrogen bonding, thus improving stability of the color-developing agent in the recording layers 43, 45, and 47.

In a case where the formulas (2) and (3) contain a hydrocarbon group, the hydrocarbon group is a generic term of a group configured by carbon (C) and hydrogen (H), and may be a saturated hydrocarbon group or an unsaturated hydrocarbon group. The saturated hydrocarbon group is an aliphatic hydrocarbon group having no carbon-carbon multiple bond, and the unsaturated hydrocarbon group is an aliphatic hydrocarbon group having a carbon-carbon multiple bond (a carbon-carbon double bond or a carbon-carbon triple bond).

In a case where the formulas (2) and (3) contain a hydrocarbon group, the hydrocarbon group may be chain-shaped, or may contain one or two or more rings. The chain chape may be a linear shape or a branched shape having one or two or more side chains or the like.

(X⁰ and X¹ Containing One Benzene Ring)

X⁰ in the formula (2) and X¹ in the formula (3) are each, for example, a divalent group containing one benzene ring. The divalent group is represented by, for example, the following formula (4).

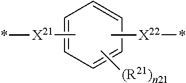

In the formula (4), X²¹ may be or may not be present; in a case where X²¹ is present, X²¹ is a divalent group. X²² may be or may not be present; in a case where X²² is present, X²² is a divalent group. R²¹ is a monovalent group. n21 is an integer of any of 0 to 4. In a case where n21 is an integer of any of 2 to 4, R²¹ may be the same as or different from each other. The sign * denotes a bond.

In the formula (4), bonding positions of X²¹ and X²² to the benzene ring are not limited. That is, the bonding positions of X²¹ and X²² to the benzene ring may be any of an ortho position, a meta position, or a para position.

From the viewpoint of an improvement in high-temperature high-humidity storage characteristics, the above-described divalent group containing one benzene ring is preferably represented by the following formula (5).

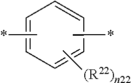

In the formula (5), R²² is a monovalent group. n22 is an integer of any of 0 to 4. In a case where n22 is an integer of any of 2 to 4, R²² may be the same as or different from each other. The sign * denotes a bond.

In a case where X⁰ in the formula (2) is a divalent group containing one benzene ring, bonding positions of Z⁰¹ and Z⁰² to the benzene ring are not limited in the formula (5). That is, the bonding positions of Z⁰¹ and Z⁰² to the benzene ring may be any of an ortho position, a meta position, or a para position.

In a case where X¹ in the formula (3) is a divalent group containing one benzene ring, bonding positions of Z¹¹ and Z¹² to the benzene ring are not limited in the formula (5). That is, the bonding positions of Z¹¹ and Z¹² to the benzene ring may be any of an ortho position, a meta position, or a para position.

(X²¹ and X²²)

X²¹ and X²² in the formula (4) are not particularly limited as long as X²¹ and X²² are, independently of each other, a divalent group; however, if exemplified, X²¹ and X²² are a hydrocarbon group which may have a substituent. The hydrocarbon group is preferably chain-shaped. The hydrocarbon group having a chain shape enables reduction of a melting point of the color-developing agent. This allows the color-developing agent to be melted by laser light irradiation, thus making it easier for the color-forming compound to be colored. From the viewpoint of reduction of the melting point of the color-developing agent, a normal alkyl chain, of the chain-shaped hydrocarbon group, is particularly preferable.

The number of carbon atoms of the hydrocarbon group which may have a substituent is, for example, within a range of 1 or more and 15 or less, 1 or more and 13 or less, 1 or more and 12 or less, 1 or more and 10 or less, 1 or more and 6 or less, or 1 or more and 3 or less.

In a case where X²¹ and X²² in the formula (4) are a normal alkyl group, the number of carbon atoms of the normal alkyl group is preferably 8 or less, more preferably 6 or less, still more preferably 5 or less, and particularly preferably 3 or less, from the viewpoint of high-temperature storage stability. In a case where the number of carbon atoms of the normal alkyl group is 8 or less, it is considered that thermal disturbance is less likely to occur to the color-developing agent during high-temperature storage because of short length of the normal alkyl group; thus a portion interacted, when being colored, with the color-forming compound such as a leuco dye is less likely to be removed. Accordingly, the color-forming compound such as the leuco dye is less likely to be decolored during high-temperature storage, thus improving the high-temperature storage stability.

Examples of the substituent which may be contained in the hydrocarbon group include a halogen group (e.g., a fluorine group) and an alkyl group having a halogen group (e.g., a fluorine group). The hydrocarbon group which may have a substituent may be a hydrocarbon group in which some of carbon atoms of the hydrocarbon group (e.g., some of carbon atoms contained in a main chain of the hydrocarbon group) are substituted with elements such as oxygen.

### (R²¹)

R²¹ in the formula (4) is not particularly limited as long as R²¹ is a monovalent group; however, if exemplified, R²¹ is a halogen group or a hydrocarbon group which may have a substituent. The halogen group is, for example, a fluorine group (—F), a chlorine group (—Cl), a bromine group (—Br), or an iodine group (—I).

The number of carbon atoms of the hydrocarbon group which may have a substituent is, for example, within a range of 1 or more and 15 or less, 1 or more and 13 or less, 1 or more and 12 or less, 1 or more and 10 or less, 1 or more and 6 or less, or 1 or more and 3 or less. Examples of the substituent which may be contained in the hydrocarbon group include a halogen group (e.g., a fluorine group) and an alkyl group having a halogen group (e.g., a fluorine group). The hydrocarbon group which may have a substituent may be a hydrocarbon group in which some of carbon atoms of the hydrocarbon group (e.g., some of carbon atoms contained in a main chain of the hydrocarbon group) are substituted with elements such as oxygen.

### (R²²)

R²² in the formula (5) is not particularly limited as long as R²² is a monovalent group; however, if exemplified, R²¹ is a halogen group or a hydrocarbon group which may have a substituent. Each of the halogen group and the hydrocarbon group which may have a substituent is similar to that mentioned for R²¹ in the above formula (2).

(X⁰ and X¹ Containing Two Benzene Rings)

X⁰ in the formula (2) and X¹ in the formula (3) are each, for example, a divalent group containing two benzene rings. The divalent group is represented by, for example, the following formula (6).

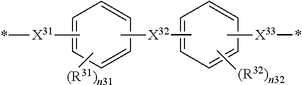

In the formula (6), X³¹ may be or may not be present; in a case where X³¹ is present, X³¹ is a divalent group. X³² may be or may not be present; in a case where X³² is present, X³² is a divalent group. X³³ may be or may not be present; in a case where X³³ is present, X³³ is a divalent group. R³¹ and R³² are, independently of each other, a monovalent group. n31 and n32 are, independently of each other, an integer of any of 0 to 4. In a case where n31 is an integer of any of 2 to 4, R³¹ may be the same as or different from each other. In a case where n32 is an integer of any of 2 to 4, R³² may be the same as or different from each other. The sign * denotes a bond.

In the formula (6), bonding positions of X³¹ and X³² to the benzene ring are not limited. That is, the bonding positions of X³¹ and X³² to the benzene ring may be any of an ortho position, a meta position, or a para position. Likewise, in the formula (6), bonding positions of X³² and X³³ to the benzene ring are not limited. That is, the bonding positions of X³² and X³³ to the benzene ring may be any of an ortho position, a meta position, or a para position.

From the viewpoint of an improvement in high-temperature high-humidity storage characteristics, the above-described divalent group containing two benzene rings is preferably represented by the following formula (7).

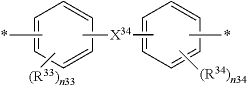

In the formula (7), X³⁴ is a divalent group. R³³ and R³⁴ are, independently of each other, a monovalent group. n33 and n34 are, independently of each other, an integer of any of 0 to 4. In a case where n33 is an integer of any of 2 to 4, R³³ may be the same as or different from each other. In a case where n34 is an integer of any of 2 to 4, R³⁴ may be the same as or different from each other. The sign * denotes a bond.

In a case where X⁰ in the formula (2) is a divalent group containing two benzene rings, bonding positions of Z⁰¹ and X³⁴ to the benzene ring are not limited in the formula (7). That is, the bonding positions of Z⁰¹ and X³⁴ to the benzene ring may be any of an ortho position, a meta position, or a para position. Likewise, bonding positions of Z⁰² and X³⁴ to the benzene ring are not limited in the formula (7). That is, the bonding positions of Z⁰² and X³⁴ to the benzene ring may be any of an ortho position, a meta position, or a para position.

In a case where X¹ in the formula (3) is a divalent group containing two benzene rings, bonding positions of Z¹¹ and X³⁴ to the benzene ring are not limited in the formula (7). That is, the bonding positions of Z¹¹ and X³⁴ to the benzene ring may be any of an ortho position, a meta position, or a para position. Likewise, bonding positions of Z¹² and X³⁴ to the benzene ring are not limited in the formula (7). That is, the bonding positions of Z¹² and X³⁴ to the benzene ring may be any of an ortho position, a meta position, or a para position.

(X³¹, X³², and X³³)

X³¹, X³², and X³³ in the formula (6) are not particularly limited as long as X³¹, X³², and X³³ are, independently of one another, a divalent group; however, if exemplified, X³¹, X³², and X³³ are a hydrocarbon group which may have a substituent. The hydrocarbon group is similar to that mentioned for X²¹ and X²² in the above formula (4).

### (X³⁴)

X³⁴ in the formula (7) is not particularly limited as long as X³⁴ is a divalent group; however, if exemplified, X³⁴ is a hydrocarbon group which may have a substituent. The hydrocarbon group is similar to that mentioned for X²¹ and X²² in the above formula (4).

(R³¹ and R³²)

R³¹ and R³² in the formula (6) are not particularly limited as long as R³¹ and R³² are a monovalent group; however, if exemplified, R³¹ and R³² are a halogen group or a hydrocarbon group which may have a substituent. Each of the halogen group and the hydrocarbon group which may have a substituent is similar to that mentioned for R²¹ in the above formula (4).

(R³³ and R³⁴)

R³³ and R³⁴ in the formula (7) are not particularly limited as long as R³³ and R³⁴ are a monovalent group; however, if exemplified, R³³ and R³⁴ are a halogen group or a hydrocarbon group which may have a substituent. Each of the halogen group and the hydrocarbon group which may have a substituent is similar to that mentioned for R²¹ in the above formula (4).

(Y⁰¹ and Y⁰²)

Y⁰¹ and Y⁰² in the formula (2) are, independently of each other, for example, a hydrogen group (—H), a hydroxy group (—OH), a halogen group (—X), a carboxy group (—COOH), an ester group (—COOR), or a hydrocarbon group which may have a substituent. The halogen group is, for example, a fluorine group (—F), a chlorine group (—Cl), a bromine group (—Br), or an iodine group (—I).

The number of carbon atoms of the hydrocarbon group which may have a substituent is, for example, within a range of 1 or more and 15 or less, 1 or more and 13 or less, 1 or more and 12 or less, 1 or more and 10 or less, 1 or more and 6 or less, or 1 or more and 3 or less. Examples of the substituent which may be contained in the hydrocarbon group include a halogen group (e.g., a fluorine group), an alkyl group having a halogen group (e.g., a fluorine group), and the like. The hydrocarbon group which may have a substituent may be a hydrocarbon group in which some of carbon atoms of the hydrocarbon group (e.g., some of carbon atoms contained in a main chain of the hydrocarbon group) are substituted with elements such as oxygen.

In the formula (2), it is preferable that one of (Y⁰¹)ₙ₀₁ and/or one of (Y⁰²)ₙ₀₂ be a hydroxy group (—OH). The one of (Y⁰¹)ₙ₀₁ and/or the one of (Y⁰²)ₙ₀₂ being a hydroxy group (—OH)) makes it possible to improve display quality and light resistance.

(Y¹¹, Y¹², Y¹³, and Y¹⁴)

In the formula (3), bonding positions of Y¹ and Y¹² to the benzene ring are not limited. That is, the bonding positions of Y¹¹ and Y¹² to the benzene ring may be any of an ortho position, a meta position, or a para position. Likewise, bonding positions of Y¹³ and Y¹⁴ to the benzene ring are not limited in the formula (3), either. That is, the bonding positions of Y¹³ and Y¹⁴ to the benzene ring may also be any of an ortho position, a meta position, or a para position. In the formula (3), the bonding positions of Y¹¹ and Y¹² to one benzene and the bonding positions of Y¹³ and Y¹⁴ to the other benzene may be the same as or different from each other.

Y¹, Y¹², Y¹³, and Y¹⁴ in the formula (3) are, independently of one another, for example, a hydrogen group (—H), a hydroxy group (—OH), a halogen group, a carboxy group (—COOH), an ester group (—COOR), or a hydrocarbon group which may have a substituent. Each of the halogen group and the hydrocarbon group which may have a substituent is similar to that mentioned for Y⁰¹ and Y⁰² in the above formula (2).

In the formula (3), it is preferred that Y¹¹ and/or Y¹³ be a hydroxy group (—OH). Y¹¹ and/or Y¹³ being a hydroxy group (—OH) makes it possible to improve display quality and light resistance.

(Z⁰¹ and Z⁰²)

Z⁰¹ and Z⁰² in the formula (2) are, independently of each other, for example, a urea bond (—NHCONH—), an amide bond (—NHCO—, —OCHN—), or a hydrazide bond (—NHCOCONH—). From the viewpoint of an improvement in high-temperature high-humidity storage characteristics, Z⁰¹ and Z⁰² are preferably a urea bond. In a case where Z⁰¹ is an amide bond, nitrogen included in the amide bond may be bonded to benzene, or carbon included in the amide bond may be bonded to benzene. In a case where Z⁰² is an amide bond, nitrogen included in the amide bond may be bonded to benzene, or carbon included in the amide bond may be bonded to benzene.

(Z¹¹ and Z¹²)

Z¹¹ and Z¹² in the formula (2) are, independently of each other, for example, a urea bond (—NHCONH—), an amide bond (—NHCO—, —OCHN—), or a hydrazide bond (—NHCOCONH—). From the viewpoint of an improvement in high-temperature high-humidity storage characteristics, Z¹¹ and Z¹² are preferably a urea bond. In a case where Z¹¹ is an amide bond, nitrogen included in the amide bond may be bonded to benzene, or carbon included in the amide bond may be bonded to benzene. In a case where Z¹² is an amide bond, nitrogen included in the amide bond may be bonded to benzene, or carbon included in the amide bond may be bonded to benzene.

### (Specific Example of Color-Developing/Reducing Agent)

Examples of the color-developing/reducing agent include, in addition to those mentioned above, 4,4′-isopropylidenebisphenol, 4,4′-isopropylidenebis(o-methylphenol), 4,4′-secondary butylidenebisphenol, 4,4′-isopropylidenebis(2-tertiary butylphenol), zinc p-nitrobenzoate, 1,3,5-tris(4-tertiary butyl-3-hydroxy-2,6-dimethylbenzyl)isocyanuric acid, 2,2-(3,4′-dihydroxydiphenyl)propane, bis(4-hydroxy-3-methylphenyl)sulfide, 4-{β-(p-methoxyphenoxy)ethoxy}salicylic acid, 1,7-bis(4-hydroxyphenylthio)-3,5-dioxaheptane, 1,5-bis(4-hydroxyphenylthio)-5-oxapentane, phthalic acid monobenzyl ester monocalcium salt, 4,4′-cyclohexylidenediphenol, 4,4′-isopropylidenebis(2-chlorophenol), 2,2′-methylenebis(4-methyl-6-tertiary-butylphenol), 4,4′-butylidenebis(6-tertiary-butyl-2-methyl)phenol, 1,1,3-tris(2-methyl-4-hydroxy-5-tertiary-butylphenyl)butane, 1,1,3-tris(2-methyl-4-hydroxy-5-cyclohexylphenyl)butane, 4,4′-thiobis(6-tertiary-butyl-2-methyl)phenol, 4,4′-diphenolsulfone, 4-isopropoxy-4′-hydroxydiphenylsulfone(4-hydroxy-4′-isopropoxydiphenylsulfone), 4-benzyloxy-4′-hydroxydiphenylsulfone, 4,4′-diphenolsulfoxide, isopropyl p-hydroxybenzoate, benzyl p-hydroxybenzoate, benzyl protocatechuate, stearyl gallate, lauryl gallate, octyl gallate, 1,3-bis(4-hydroxyphenylthio)-propane, N,N′-diphenylthiourea, N,N′-di(m-chlorophenyl)thiourea, salicylanilide, bis(4-hydroxyphenyl)acetic acid methyl ester, bis(4-hydroxyphenyl)acetic acid benzyl ester, 1,3-bis(4-hydroxycumyl)benzene, 1,4-bis(4-hydroxycumyl)benzene, 2,4′-diphenolsulfone, 2,2′-diallyl-4,4′-diphenolsulfone, 3,4-dihydroxyphenyl-4′-methyldiphenylsulfone, zinc 1-acetyloxy-2-naphthoate, zinc 2-acetyloxy-1-naphthoate, zinc 2-acetyloxy-3-naphthoate, α,α-bis(4-hydroxyphenyl)-α-methyltoluene, an antipyrine complex of zinc thiocyanate, tetrabromobisphenol A, tetrabromobisphenol S, 4,4′-thiobis(2-methylphenol), 4,4′-thiobis(2-chlorophenol), dodecylphosphonic acid, tetradecylphosphonic acid, hexadecylphosphonic acid, octadecylphosphonic acid, eicosylphosphonic acid, docosylphosphonic acid, tetracosylphosphonic acid, hexacosylphosphonic acid, octacosylphosphonic acid, α-hydroxydodecylphosphonic acid, α-hydroxytetradecylphosphonic acid, α-hydroxyhexadecylphosphonic acid, α-hydroxyoctadecylphosphonic acid, α-hydroxyeicosylphosphonic acid, α-hydroxydocosylphosphonic acid, α-hydroxytetracosylphosphonic acid, dihexadecyl phosphate, dioctadecyl phosphate, dieicosyl phosphate, didocosyl phosphate, monohexadecyl phosphate, monooctadecyl phosphate, monoeicosyl phosphate, monodocosyl phosphate, methylhexadecyl phosphate, methyloctadecyl phosphate, methyleicosyl phosphate, methyldocosyl phosphate, amylhexadecyl phosphate, octylhexadecyl phosphate, lauryl hexadecyl phosphate, and the like. In the recording layers 13, 15, and 17, one of the above-mentioned compounds may be used alone, or two or more thereof may be used in combination, as the color-developing/reducing agent.

The photothermal converting agent absorbs light in a predetermined wavelength region of a near-infrared region, for example, to generate heat. It is preferable to use, as the photothermal converting agent, for example, a near-infrared ray absorbing dye having an absorption peak within a wavelength range of 700 nm or more and 2500 nm or less and having almost no absorption in a visible region. Specific examples thereof include a compound having a phthalocyanine skeleton (a phthalocyanine-based dye), a compound having a naphthalocyanine skeleton (a naphthalocyanine-based dye), a compound having a squarylium skeleton (a squarylium-based dye), a metal complex such as a dithio complex, a diimonium salt, an aminium salt, an inorganic compound, and the like. Examples of the inorganic compound include graphite, carbon black, metal powder particles, tricobalt tetroxide, iron oxide, chromium oxide, copper oxide, titanium black, and a metal oxide such as ITO, a metal nitride such as niobium nitride, a metal carbide such as tantalum carbide, a metal sulfide, various magnetic powders, and the like. In addition thereto, a compound having a cyanine skeleton (a cyanine-based dye) with superior light resistance and superior heat resistance may be used.

It is to be noted that it is preferable to select, as the photothermal converting agent, for example, the one which has narrow light absorption bands within a wavelength range of 700 nm or more and 2000 nm or less and which allow the light absorption bands not to overlap one another in the recording layers 43, 45, and 47. This enables a desired layer of the recording layers 43, 45, and 47 to be selectively colored.

It is to be noted that the term superior light resistance means no decomposition during laser irradiation. The term superior heat resistance means that, for example, no change of 20% or more occurs to a maximum absorption peak value of an absorption spectrum, when a film is formed together with a matrix resin (macromolecular material) and stored at 150° C. for 30 minutes, for example. Examples of such a compound having a cyanine skeleton include a compound containing, in a molecule, at least one of a counter ion of any of SbF₆, PF₆, BF₄, ClO₄, CF₃SO₃, and (CF₆SO₃)₂N, or a methine chain containing a five-membered ring or a six-membered ring.

It is preferable for the cyanine-based dye to have both of any of the above-mentioned counter ions and a ring structure such as a five-membered ring or a six-membered ring in the methine chain. However, having at least one thereof ensures sufficient light resistance and sufficient heat resistance. A material with superior light resistance and superior heat resistance does not decompose during laser irradiation, as described above. Examples of a method to confirm light resistance include a method of measuring a peak change of an absorption spectrum during a xenon lamp illumination test. When a change rate at the time of 30-minute irradiation is 20% or less, it can be judged that light resistance is good. Examples of a method to confirm heat resistance include a method of measuring a peak change of an absorption spectrum during storage at 150° C. When a change rate after 30-minute test is 20% or less, it can be judged that heat resistance is good.

As for the matrix resin (macromolecular material), it is preferable for the color-forming compound, the color-developing agent, and the photothermal converting agent to be easily dispersed homogeneously. In addition, in order to obtain high visibility of information written into the recording layers 43, 45, and 47, it is preferable for the matrix resin (macromolecular material) to have high transparency; for example, it is preferable to have high solubility in an organic solvent. Examples of the matrix resin (macromolecular material) include at least one selected from the group consisting of a thermosetting resin and a thermoplastic resin. Specific examples thereof include at least one selected from the group consisting of a polyvinyl chloride-based resin, a polyvinyl acetate-based resin, a vinyl chloride-vinyl acetate copolymer-based resin, an ethyl cellulose-based resin, a polystyrene-based resin, a styrene-based copolymer-based resin, a phenoxy resin-based resin, a polyester-based resin, an aromatic polyester-based resin, a polyurethane-based resin, a polycarbonate-based resin, a polyacrylic acid ester-based resin, a polymethacrylic acid ester-based resin, an acrylic acid-based copolymer-based resin, a maleic acid-based polymer-based resin, a polyvinyl alcohol-based resin, a modified polyvinyl alcohol-based resin, a hydroxyethyl cellulose-based resin, a carboxymethyl cellulose-based resin, starch, and the like.

The matrix polymer preferably includes a polycarbonate-based resin. The matrix polymer including a polycarbonate-based resin makes it possible to improve light resistance of a background of the recording medium 20. As used herein, the polycarbonate-based resin refers to a resin having, as a structure unit, a carbonate group (—O—(C═O)—O—) at least in the main chain. Accordingly, another structure unit may be included in the main chain, in addition to the carbonate group.

The underlayer 42 is provided between the base material 41 and the recording layer 43. The intermediate layer 44 is provided between the recording layer 43 and the recording layer 45. The intermediate layer 46 is provided between the recording layer 45 and the recording layer 47. The underlayer 42 and the intermediate layers 44 and 36 may be able to insulate layers from each other, and may be able to suppress diffusion of the constituent material.

The underlayer 42 and the intermediate layers 44 and 46 include, for example, a macromolecular material having a typical light transmissivity. Specific examples of the material include at least one selected from the group consisting of an acrylic-based resin, a polyvinyl chloride-based resin, a polyvinyl acetate-based resin, a vinyl chloride-vinyl acetate copolymer-based resin, an ethyl cellulose-based resin, a polystyrene-based resin, a styrene-based copolymer-based resin, a phenoxy resin-based resin, a polyester-based resin, an aromatic polyester-based resin, a polyurethane-based resin, a polycarbonate-based resin, a polyacrylic acid ester-based resin, a polymethacrylic acid ester-based resin, an acrylic acid-based copolymer-based resin, a maleic acid-based polymer-based resin, a polyvinyl alcohol-based resin, a modified polyvinyl alcohol-based resin, a hydroxyethyl cellulose-based resin, a carboxymethyl cellulose-based resin, starch, and the like. It is to be noted that the underlayer 42 and the intermediate layers 44 and 46 may include, for example, various additives such as an ultraviolet absorber.

The underlayer 42 and the intermediate layers 44 and 46 may each be an ultraviolet curable resin layer. The ultraviolet curable resin layer includes an ultraviolet curable resin composition having been subjected to a polymerization reaction and solidified. More specifically, for example, the ultraviolet curable resin layer includes a polymer of a polymerizable compound and a polymerization initiator that is caused to generate active species by irradiation of external energy (ultraviolet ray) to result in a structural change. The ultraviolet curable resin composition includes, for example, at least one selected from the group consisting of a radically polymerized ultraviolet curable resin composition, a cationically polymerized ultraviolet curable resin composition, and the like. The ultraviolet curable resin composition may include, as needed, at least one selected from the group consisting of a sensitizer, a filler, a stabilizer, a leveling agent, a defoamer, a viscosity-adjusting agent, and the like. The ultraviolet curable resin composition may be an ultraviolet curable resin composition for hard coat. The ultraviolet curable resin composition may be an acrylic-based ultraviolet curable resin composition.

The underlayer 42 and the intermediate layers 44 and 46 may each include an inorganic material having light transmissivity. For example, using porous silica, alumina, titania, carbon, a composite thereof, or the like causes thermal conductivity to be lowed, thus allowing for a high thermal insulation effect, which is preferable. The underlayer 42 and the intermediate layers 44 and 366 may be formed, for example, by a sol-gel method.

Adjusting thicknesses of the intermediate layers 44 and 46 may allow a thickness of the thickest one of the identification layer 30 and the thermosensitive recording layer 40 to match the thickness of the embedded layer 21, thus suppressing generation of a physical step difference. The thickness of each of the intermediate layers 44 and 46 is preferably 3 μm or more and 100 μm or less, and more preferably 5 μm or more and 50 μm or less. When the thickness of each of the intermediate layers 44 and 46 is 3 μm or more, it is possible to obtain a sufficient thermal insulation effect. Meanwhile, when the thickness of each of the intermediate layers 44 and 46 is 100 μm or less, it is possible to suppress a decrease in light transmissivity. In addition, it is possible to suppress a decrease in bending resistance of each of the identification layer 30 and the thermosensitive recording layer 40, thus making a defect such as a crack less likely to occur.

A pencil hardness of each surface of the underlayer 42 and the intermediate layers 44 and 46 is preferably 2B or more, and more preferably H or more. When the pencil hardness of each surface of the underlayer 42 and the intermediate layers 44 and 46 is 2B or more, compactness of each of the underlayer 42 and the intermediate layers 44 and 46 is high, thus making it possible to further suppress substance diffusion through the underlayer 42 and the intermediate layers 44 and 46. For example, in a case where the pencil hardness of each surface of the underlayer 42 and the intermediate layers 44 and 46 is 2B or more, it is possible to further suppress diffusion of the color-forming compound through the underlayer 42 and the intermediate layers 44 and 46. It is therefore possible to further suppress a change in a color hue of each of the recording layers 43, 45, and 47 upon long-term storage, or the like. The ultraviolet curable resin layer is preferable as the underlayer 42 and the intermediate layers 44 and 46 each having the above-described pencil hardness.

The pencil hardness of the surface of the intermediate layer 44 is measured as follows. First, the thermosensitive recording layer 40 is decomposed to expose the surface of the intermediate layer 44. Next, the pencil hardness of the surface of the intermediate layer 44 is measured in compliance with JISK5600-5-4. As for this measurement, the pencil hardness of the surface of the intermediate layer 44, for which measurement is conducted in the atmosphere of a standard state of a temperature of 23±1° C. and a relative humidity of 50±5%, is also measured in a procedure similar to that for the pencil hardness of the surface of the underlayer 42.

The protective layer 48 is adapted to protect the surface of the thermosensitive recording layer 40, and is formed using, for example, at least one of an ultraviolet curable resin or a thermosetting resin. The protective layer 48 may be a hard coat layer. In order to provide physical resistance, a plastic film similar to that in the base material 41 or a matrix polymer may be used for the protective layer 48. In order to combine a protective function, a plurality of protective layers may be attached together using a gluing agent, for example. A thickness of the protective layer 48 is, for example, 0.1 μm or more and 100 μm or less.

In the thermosensitive recording layer 40, a gluing agent layer may be provided between the base material 41 and the underlayer 42, between the underlayer 42 and the recording layer 43, between the recording layer 43 and the intermediate layer 44, between the intermediate layer 44 and the recording layer 45, between the recording layer 45 and the intermediate layer 46, and between the intermediate layer 46 and the recording layer 47. The gluing agent layer includes a glueing agent. The gluing agent includes, for example, at least one selected from the group consisting of an acrylic-based resin, a silicone-based resin, a urethane-based resin, an epoxy-based resin, and an elastomer-based material.

In the identification element 1, for example, an adhesive layer may be provided between the support substrate 10 and the embedded layer 21 or between the embedded layer 21 and the cover layer 22. The adhesive layer includes a thermal adhesive, for example. The thermal adhesive includes a thermosetting resin, for example. The thermosetting resin includes, for example, at least one selected from the group consisting of an epoxy-based resin, a urethane-based resin, and the like. A curing temperature of the thermal adhesive is preferably within a temperature range of 100° C. or more and 120° C. or less, from the viewpoint of reducing damage to the thermosensitive recording layer 40.

The identification element 1 may include a laser marking layer. The identification element 1 may include the laser marking layer, for example, in the support substrate 10, between the support substrate 10 and the thermosensitive recording medium 20, or in the thermosensitive recording medium 20. The laser marking layer is disposed in the thermosensitive recording medium 20 or at least at a location opposed to the thermosensitive recording medium 20. It is to be noted that the laser marking layer may be disposed at a location that is non-opposed to the thermosensitive recording medium 20.

The laser marking layer is configured to be able to change a state of coloring by an external stimulus such as laser light or heat. The laser marking layer is configured by, for example, a material that enables black or a dark color to be developed by an external stimulus such as laser light or heat. The laser marking layer is different from the recording layers 43, 45, and 47 in terms of a recording method (different coloring principles in recording methods).

The laser marking layer for use in the identification element 1 may be a known laser marking sheet. The laser marking layer is a thermosensitive recording layer configured to enable laser marking, for example, by means of at least one of the following methods (1) to (5).
(1) A method of foaming and coloring a resin material
(2) A method of adding an additive that absorbs laser light to a resin material to color the additive itself
(3) A method of adding an additive that absorbs laser light to a resin material and heating the additive, thereby carbonizing a surrounding resin material to develop a color
(4) A method of engraving a surface of a resin layer by laser irradiation and using a change in a state of the surface
(5) A method of marking by irradiating a black or dark-colored resin material with laser light, thereby sublimating (decomposing) and decolorizing (exposing a ground color of the resin material) a colorant (carbon black)

The laser marking layer includes, for example, a photothermal converting agent and a resin material. The resin material for use in the laser marking layer includes, for example, a polycarbonate-based resin. The photothermal converting agent for use in the laser marking layer, for example, absorbs light in a predetermined wavelength region of the near-infrared region and generates heat. It is preferable to select, as the photothermal converting agent for use in the laser marking layer, for example, the one having a narrow light absorption band in the near-infrared region and having a light-absorbing wavelength range that does not overlap the light absorption band of the thermosensitive recording layer 40. The photothermal converting agent for use in the laser marking layer includes carbon, for example.

### [Method of Manufacturing Identification Element 1]

Next, description is given of an example of a method of manufacturing the identification element 1.

First, a thermosetting resin is applied as a thermal adhesive to one main surface of the support substrate 10 to form an adhesive layer. Next, a thermosetting resin is applied to a surface of the embedded layer 21 into which the identification layer 30 and an undrawn thermosensitive recording layer 40A are fitted in advance, and then the embedded layer 21 is placed on the main surface of the support substrate 10, with a coated film interposed therebetween.

Next, a thermosetting resin is applied as a thermal adhesive on the embedded layer 21 to form an adhesive layer, and then the cover layer 22 is placed on the adhesive layer. Next, a stack thus formed is sandwiched between metal plates and is pressurized while being heated to thereby thermally cure the adhesive layer. A temperature to be applied to the stack upon the thermal curing is preferably 100° C. or more and 120° C. or less, from the viewpoint of reducing damage to the identification layer 30 and the thermosensitive recording layer 40A. It is to be noted that thermal lamination may be performed on the stack formed as described above to thereby thermally cure the adhesive layer. In this manner, for example, an undrawn identification element 1′ as illustrated in FIG. 5 is manufactured.

Next, for example, as illustrated in FIG. 6, the thermosensitive recording layer 40A is irradiated with laser light L1. This allows for formation of the thermosensitive recording layer 40 with image information on a user being embedded in the thermosensitive recording layer 40A (i.e., with an image being drawn on the thermosensitive recording layer 40A). In this manner, for example, the drawn identification element 1 as illustrated in FIGS. 1 and 2 is manufactured. It is to be noted that detailed description is given later of the method of recording into the identification element 1′.

It is to be noted that, in the present embodiment, the above-described adhesive layer may be omitted to attach the support substrate 10 and the embedded layer 21 to each other by fusion and to attach the embedded layer 21 and the cover layer 22 to each other by fusion.

At this time, the support substrate 10, the embedded layer 21, and the cover layer 22 preferably include a thermoplastic resin as plastic. The thermoplastic resin included in the support substrate 10, the embedded layer 21, and the cover layer 22 makes it possible to increase interlayer adhesion strength obtained by fusion. From the viewpoint of reducing damage to the thermosensitive recording layer 40, the thermoplastic resin is preferably able to thermally fuse the support substrate 10 and the embedded layer 21 together and thermally fuse the embedded layer 21 and the cover layer 22 together, within a temperature range of 130° C. or more and 200° C. or less.

The support substrate 10, the embedded layer 21, and the cover layer 22 may include a thermoplastic resin of the same type; alternatively, the support substrate 10, the embedded layer 21, and the cover layer 22 may not include a thermoplastic resin of the same type. In a case where the support substrate 10, the embedded layer 21, and the cover layer 22 do not include a thermoplastic resin of the same type, one of the support substrate 10, the embedded layer 21, and the cover layer 22 may include a thermoplastic resin of a type different from that of the other two layers. In a case where the support substrate 10, the embedded layer 21, and the cover layer 22 do not include a thermoplastic resin of the same type, the support substrate 10, the embedded layer 21, and the cover layer 22 may include respective thermoplastic resins of different types.

In a case where the support substrate 10, the embedded layer 21, and the cover layer 22 include a thermoplastic resin of the same type, the support substrate 10, the embedded layer 21, and the cover layer 22 preferably include at least one selected from the group consisting of a semicrystalline thermoplastic resin and a non-crystalline thermoplastic resin, from the viewpoint of an improvement in the interlayer adhesion strength by fusion.

The semicrystalline thermoplastic resin includes, for example, at least one selected from the group consisting of polypropylene (PP), polyethylene (PE), polyacetal (POM), polyethylene terephthalate (PET), polybutylene terephthalate (PBT), polyphenylene sulfide (PPS), polyether ether ketone (PEEK), and the like.

The non-crystalline thermoplastic resin includes, for example, at least one selected from the group consisting of an ABS resin, polycarbonate (PC), a polymer alloy of an ABS resin and PC (hereinafter, referred to as an “ABS/PC polymer alloy”), an AS resin, polystyrene (PS), polymethyl methacrylate (PMMA), polyphenylene oxide (PPO), polysulfone (PSU), polyvinyl chloride (PVC), polyetherimide (PEI), polyether sulfone (PES), and the like.

In a case where the support substrate 10, the embedded layer 21, and the cover layer 22 do not include a thermoplastic resin of the same type, the support substrate 10, the embedded layer 21, and the cover layer 22 each preferably include a non-crystalline thermoplastic resin, from the viewpoint of an improvement in the interlayer adhesion strength by fusion.

A preferable combination of respective non-crystalline thermoplastic resins included in the support substrate 10 and the embedded layer 21 or a preferable combination of respective non-crystalline thermoplastic resins included in the embedded layer 21 and the cover layer 22 is as follows. For example, in a case where one layer includes an ABS resin, another layer preferably includes at least one selected from the group consisting of an ABS/PC polymer alloy, polycarbonate (PC), an AS resin, polystyrene (PS), polymethyl methacrylate (PMMA), and polyvinyl chloride (PVC).

In a case where the one layer includes an ABS/PC polymer alloy, the other layer preferably includes at least one selected from the group consisting of an ABS resin, polycarbonate (PC), and polymethyl methacrylate (PMMA). In a case where the one layer includes polycarbonate (PC), the other layer preferably includes at least one selected from the group consisting of an ABS resin, an ABS/PC polymer alloy, and polymethyl methacrylate (PMMA).

In a case where the one layer includes an AS resin, the other layer preferably includes at least one selected from the group consisting of an ABS resin, polystyrene (PS), polymethyl methacrylate (PMMA), and polyphenylene oxide (PPO). In a case where the one layer includes polystyrene (PS), the other layer preferably includes at least one selected from the group consisting of an AS resin and polyphenylene oxide (PPO).

In a case where the one layer includes polymethyl methacrylate (PMMA), the other layer preferably includes at least one selected from the group consisting of an ABS resin, an ABS/PC polymer alloy, an AS resin, and polyphenylene oxide (PPO). In a case where the one layer includes polyphenylene oxide (PPO), the other layer preferably includes at least one selected from the group consisting of polycarbonate (PC), an AS resin, polystyrene (PS), and polymethyl methacrylate (PMMA).

In a case where the one layer includes polysulfone (PSU), the other layer preferably includes polycarbonate (PC). In a case where the one layer includes polyvinyl chloride (PVC), the other layer preferably includes an ABS resin.

Next, description is given of an example of a method of manufacturing the undrawn identification element 1′ using fusion. First, the embedded layer 21 into which the identification layer 30 and the undrawn thermosensitive recording layer 40A are fitted in advance is placed on one main surface of the support substrate 10. Next, the cover layer 22 is placed on the embedded layer 21. Next, a stack including the support substrate 10, the embedded layer 21, and the cover layer 22 is sandwiched between metal plates, and is pressurized while being heated, thereby thermally fusing the support substrate 10 and the embedded layer 21 together and thermally fusing the embedded layer 21 and the cover layer 22 together. A temperature to be applied to the stack upon the thermal fusing is preferably 130° C. or more and 200° C. or less, from the viewpoint of reducing damage to the identification layer 30 and the thermosensitive recording layer 40A and from the viewpoint of developing sufficient fusion strength. This enables manufacture of the identification element 1′ by fusion.

Next, description is given of a method of recording into the identification element 1′ and a method of authentication of the recorded identification element 1.

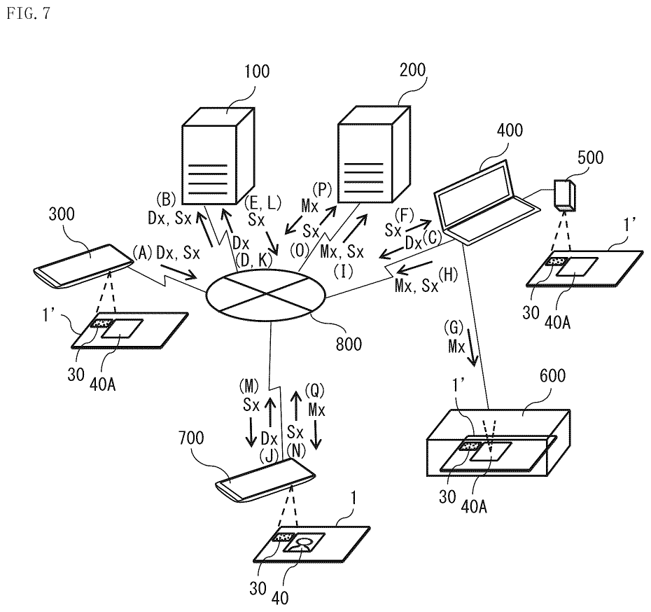

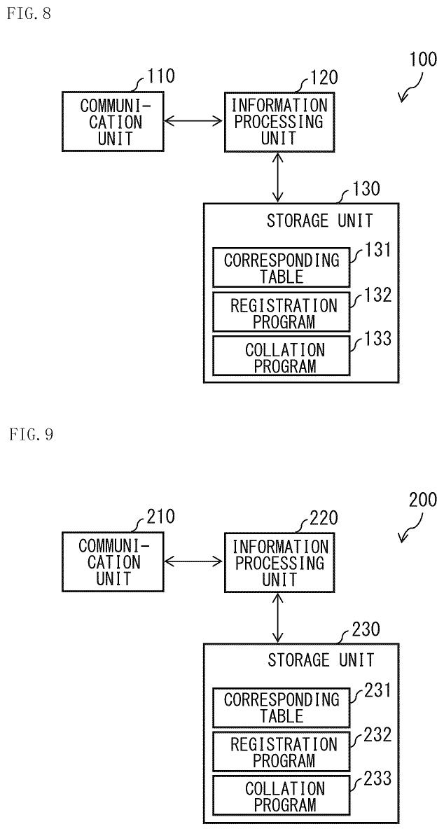

FIG. 7 illustrates an example of a schematic configuration of an authentication system that authenticates the identification element 1. It is to be noted that FIG. 7 also illustrates data transmission and reception between apparatuses in the authentication system; however, the data transmission and reception between the apparatuses in the authentication system are described together, upon description for FIGS. 14 to 16. Hereinafter, description is given first of an overview of each of the apparatuses that appear in FIG. 7, and detailed description is given of an internal configuration of each of the apparatuses with reference to FIGS. 8 to 13. Thereafter, detailed description is given, with reference to FIGS. 14 to 16 and FIG. 7, of the data transmission and reception between the apparatuses in the authentication system. It is to be noted that A, B, C, . . . , and Q in FIG. 7 are symbols assigned to data transmission from the apparatuses or data reception in the apparatuses.

The authentication system includes, for example, collation apparatuses 100 and 200, a registration apparatus 300, an inquiry/registration apparatus 400, an imaging apparatus 500, a drawing apparatus 600, and an inquiry apparatus 700, as illustrated in FIG. 7. The collation apparatuses 100 and 200, the registration apparatus 300, the inquiry/registration apparatus 400, and the inquiry apparatus 700 are coupled to a communication network 800, and are communicable to each other via the communication network 800. The communication network 800 includes, for example, the Internet, a cloud network, or a network unique to a business operator.

When individual identification information Dx and a serial number Sx are inputted as registration information (B) from the registration apparatus 300, the collation apparatus 100 is able to register the inputted registration information in a storage unit 130 (described later) of the collation apparatus 100. The collation apparatus 100 is an apparatus that, when an inquiry about the individual identification information Dx (D or K) is requested from the inquiry/registration apparatus 400 or the inquiry apparatus 700, is able to collate the requested individual identification information Dx and already registered individual identification information with each other. The collation apparatus 100 is able to transmit a collation result (E or L) as an inquiry result to the apparatus having made the request (the inquiry/registration apparatus 400 or the inquiry apparatus 700). When the collation is successful, the collation apparatus 100 is able to output, as an inquiry result, the serial number Sx (E or L) corresponding to the individual identification information Dx.

When meta information Mx and the serial number Sx are inputted as registration information (I) from the inquiry/registration apparatus 400, the collation apparatus 200 is able to register the inputted registration information in a storage unit 230 (described later) of the collation apparatus 200. The collation apparatus 200 is an apparatus that, when an inquiry about the serial number Sx (O) is requested from the inquiry apparatus 700, is able to collate the requested serial number Sx and already registered serial numbers with each other. The collation apparatus 200 is able to transmit a collation result as an inquiry result (P) to an apparatus having made the request (inquiry apparatus 700). When the collation is successful, the collation apparatus 200 is able to output, as the inquiry result (P), the meta information Mx corresponding to the serial number Sx.

The registration apparatus 300 is able to acquire the individual identification information Dx from the identification element 1′, and is able to generate the serial number Sx. The registration apparatus 300 is able to transmit, as a registration request (A), the acquired individual identification information Dx and the generated serial number Sx to the collation apparatus 100 for registration thereof in the collation apparatus 100.

The inquiry/registration apparatus 400 is able to acquire image information Ix from the imaging apparatus 500, and is able to acquire the meta information Mx by a user input. The inquiry/registration apparatus 400 is able to acquire, as the individual identification information Dx, the image information Ix or feature information Cx corresponding to the image information Ix. For example, the inquiry/registration apparatus 400 is able to generate the feature information Cx having a smaller amount of data than that of the image information Ix by performing predetermined signal processing on the image information Ix. For example, the inquiry/registration apparatus 400 is able to generate the feature information Cx having the smaller amount of data than that of the image information Ix by performing predetermined encryption processing on the image information Ix.

The inquiry/registration apparatus 400 is able to make a request (C) for inquiry of the collation apparatus 100 about the acquired individual identification information Dx, and is able to acquire an inquiry result (F) thereof from the collation apparatus 100. The inquiry/registration apparatus 400 transmits, as a registration request (H), to the collation apparatus 200, the acquired meta information Mx and the serial number Sx acquired as an inquiry result to the collation apparatus 200 for registration thereof in the collation apparatus 200.

The imaging apparatus 500 is able to capture an image of the identification region 1A of the identification element 1′ under the control of the inquiry/registration apparatus 400, and is able to output the resulting image information Ix to the inquiry/registration apparatus 400.

The drawing apparatus 600 is able to draw (embed) the meta information Mx on the thermosensitive recording region 1B of the identification element 1′ under the control of the inquiry/registration apparatus 400. The drawing apparatus 600 is able to acquire the meta information Mx from the inquiry/registration apparatus 400.

The inquiry apparatus 700 is able to capture an image of the identification region 1A of the identification element 1 on which drawing has been made by the drawing apparatus 600 to thereby acquire the image information Ix. The inquiry apparatus 700 is able to acquire (detect), as the individual identification information Dx, the image information Ix or the feature information Cx corresponding to the image information Ix. The inquiry apparatus 700 is able to generate the feature information Cx having a smaller amount of data than that of the image information Ix, for example, by performing predetermined signal processing on the image information Ix. The inquiry apparatus 700 may be able to generate the feature information Cx having the smaller amount of data than that of the image information Ix, for example, by performing predetermined encryption processing on the image information Ix.

The inquiry apparatus 700 is able to make a request for inquiry of the collation apparatus 100 about the acquired individual identification information Dx (J), and is able to acquire an inquiry result (M) thereof from the collation apparatus 100. The inquiry apparatus 700 is able to make a request for inquiry of the collation apparatus 200 about the serial number Sx (N) acquired as an inquiry result from the collation apparatus 100, and is able to acquire an inquiry result (Q) thereof from the collation apparatus 200. The inquiry apparatus 700 is able to display the inquiry result acquired from the collation apparatus 200.

Next, description is given of internal configurations of the collation apparatuses 100 and 200, the registration apparatus 300, the inquiry/registration apparatus 400, the drawing apparatus 600, and the inquiry apparatus 700.

### (Collation Apparatus 100)

For example, as illustrated in FIG. 8, the collation apparatus 100 includes a communication unit 110, an information processing unit 120, and the storage unit 130.

The communication unit 110 is a communication interface that is able to communicate with the registration apparatus 300, the inquiry/registration apparatus 400, and the inquiry apparatus 700 via the communication network 800. The communication unit 110 is able to receive a registration request (B) for the individual identification information Dx and the serial number Sx from the registration apparatus 300, and is able to output the received registration request (B) to the information processing unit 120. The communication unit 110 is able to receive an inquiry request (D) for the individual identification information Dx from the inquiry/registration apparatus 400, and is able to output the received inquiry request (D) to the information processing unit 120. The communication unit 110 is able to receive an inquiry request (K) for the individual identification information Dx from the inquiry apparatus 700, and is able to output the received inquiry request (K) to the information processing unit 120. The communication unit 110 is able to output, to a request source (the inquiry/registration apparatus 400 or the inquiry apparatus 700), an inquiry result (e.g., the serial number Sx) (E, L) as a response to the inquiry request (D, K) for the individual identification information Dx.

The information processing unit 120 is configured by, for example, an MPU (Micro-Processing Unit) that performs registration and collation, or a CPU (Central Processing Unit) loaded with a registration program 132 and a collation program 133. When acquiring the registration request for the individual identification information Dx and the serial number Sx, the information processing unit 120 is able to store, in a corresponding table 131 of the storage unit 130, the individual identification information Dx and the serial number Sx included in the acquired registration request.

When acquiring the inquiry request for the individual identification information Dx, the information processing unit 120 is able to collate the individual identification information Dx included in the acquired inquiry request. The information processing unit 120 is able to compare the individual identification information Dx included in the acquired inquiry request and a plurality of pieces of individual identification information Di (1≤i≤n; n is a positive integer) included in the corresponding table 131 with each other to determine whether or not the individual identification information Dx coincides with one of the plurality of pieces of individual identification information Di included in the corresponding table 131. In a case where the individual identification information Dx coincides with the individual identification information Di included in the corresponding table 131, the information processing unit 120 is able to read a serial number Si corresponding to the individual identification information Di from the corresponding table 131, and is able to set the read serial number Si as the serial number Sx corresponding to the individual identification information Dx. At this time, the information processing unit 120 is able to output the serial number Sx as an inquiry result. In a case where the individual identification information Dx does not coincide with any of the plurality of pieces of individual identification information Di included in the corresponding table 131, the information processing unit 120 is able to output, as an inquiry result, information indicating that no collation has been made (e.g., information not including the serial number Sx).

The storage unit 130 is configured by, for example, a volatile memory such as a DRAM (Dynamic Random Access Memory), a non-volatile memory such as an EEPROM (Electrically Erasable Programmable Read-Only Memory) or a flash memory, or a recording apparatus such as an HDD (Hard Disk Drive), an optical disk drive, or a magnetic tape apparatus. The storage unit 130 stores, for example, the corresponding table 131, the registration program 132, and the collation program 133.

The corresponding table 131 stores the individual identification information Di and the serial number Si in association with each other. The corresponding table 131 stores a plurality of sets of individual identification information Di and serial number Si. The registration program 132 is a program in which a series of procedures of registration performed in the collation apparatus 100 is described. The collation program 133 is a program in which a series of procedures of collation performed in the collation apparatus 100 is described.

### (Collation Apparatus 200)

For example, as illustrated in FIG. 9, the collation apparatus 200 includes a communication unit 210, an information processing unit 220, and the storage unit 230.

The communication unit 210 is a communication interface that is able to communicate with the inquiry/registration apparatus 400 and the inquiry apparatus 700 via the communication network 800. The communication unit 210 is able to receive a registration request (I) for the meta information Mx and the serial number Sx from the inquiry/registration apparatus 400, and is able to output the received registration request (I) to the information processing unit 220. The communication unit 210 is able to receive an inquiry request (O) for the serial number Sx from the inquiry apparatus 700, and is able to output the received inquiry request (O) to the information processing unit 220. The communication unit 210 is able to output, to a request source (inquiry apparatus 700), an inquiry result (e.g., meta information Mx) (P) as a response to the inquiry request (O) for the serial number Sx.

The information processing unit 220 is configured by, for example, an MPU that performs registration and collation, or a CPU loaded with a registration program 232 and a collation program 233. When acquiring the registration request for the meta information Mx and the serial number Sx, the information processing unit 220 is able to store the meta information Mx and the serial number Sx included in the acquired registration request in a corresponding table 231 of the storage unit 230.

When acquiring the inquiry request for the serial number Sx, the information processing unit 220 is able to collate the serial number Sx included in the acquired inquiry request. The information processing unit 220 is able to compare the serial number Sx included in the acquired inquiry request and a plurality of serial numbers Si (1≤i≤n; n is a positive integer) included in the corresponding table 231 with each other to determine whether or not the serial number Sx coincides with one of the plurality of serial numbers Si included in the corresponding table 231. In a case where the serial number Sx coincides with the serial number Si included in the corresponding table 231, the information processing unit 220 is able to read meta information Mi corresponding to the serial number Si from the corresponding table 231 to set the read meta information Mi as the meta information Mx corresponding to the serial number Sx. At this time, the information processing unit 220 is able to output the meta information Mx as an inquiry result. In a case where the serial number Sx does not coincide with any of the plurality of serial numbers Si included in the corresponding table 231, the information processing unit 220 is able to output, as an inquiry result, information indicating that no collation has been made (e.g., information not including the meta information Mx).

The storage unit 230 is configured by, for example, a volatile memory such as a DRAM, a non-volatile memory such as an EEPROM or a flash memory, or a recording apparatus such as an HDD, an optical disk drive, or a magnetic tape apparatus. The storage unit 230 stores, for example, the corresponding table 231, the registration program 232, and the collation program 233.

The corresponding table 231 stores the meta information Mi and the serial number Si in association with each other. The corresponding table 231 stores a plurality of sets of meta information Mi and serial number Si. The registration program 232 is a program in which a series of procedures of registration performed in the collation apparatus 200 is described. The collation program 233 is a program in which a series of procedures of collation performed in the collation apparatus 200 is described.

### (Registration Apparatus 300)

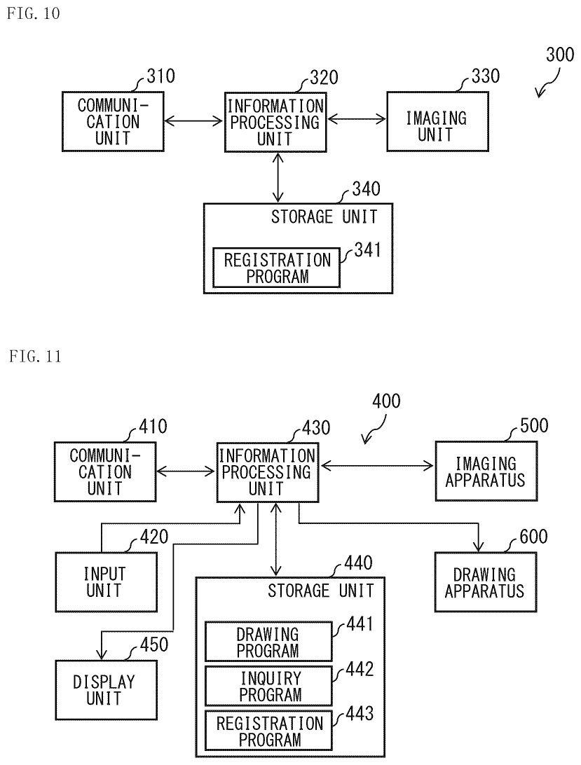

For example, as illustrated in FIG. 10, the registration apparatus 300 includes a communication unit 310, an information processing unit 320, an imaging unit 330, and a storage unit 340.

The communication unit 310 is a communication interface that is able to communicate with the inquiry apparatus 100 via the communication network 800. The communication unit 310 is able to receive the registration request (A) for the individual identification information Dx and the serial number Sx from the information processing unit 320, and is able to transmit the received registration request (A) to the registration apparatus 300.

The information processing unit 320 is configured by, for example, an MPU that performs registration or a CPU loaded with a registration program 341. The information processing unit 320 is able to instruct the imaging unit 330 to perform imaging. The information processing unit 320 is able to acquire, as the individual identification information Dx, the image information Ix obtained by the imaging unit 330 or the feature information Cx corresponding to the image information Ix. For example, the information processing unit 320 generates the feature information Cx having a smaller amount of data than that of the image information Ix by performing predetermined signal processing or encryption processing on the image information Ix. When acquiring the individual identification information Dx, the information processing unit 320 is able to generate the serial number Sx corresponding to the acquired individual identification information Dx. The information processing unit 320 is able to output, as a registration request, the individual identification information Dx and the serial number Sx associated with each other to the communication unit 310.

The storage unit 230 is configured by, for example, a volatile memory such as a DRAM, a non-volatile memory such as an EEPROM or a flash memory, or a recording apparatus such as an HDD, an optical disk drive, or a magnetic tape apparatus. The storage unit 230 stores the registration program 341, for example. The registration program 341 is a program in which a series of procedures to the output of the registration request performed in the registration apparatus 300 is described.

The imaging unit 330 includes, for example, a CMOS (Complementary Metal Oxide Semiconductor) image sensor. The imaging unit 330 may further include, for example, a flash illumination, an ultraviolet illumination, an infra-red illumination, a polarization optical system, a magnifying lens, and the like, in order to efficiently detect a physical feature of the identification region 1A. In accordance with an instruction from the information processing unit 320, the imaging unit 330 is able to perform imaging with a CMOS image sensor, and is able to output the resulting image information Ix to the information processing unit 320.

### (Inquiry/Registration Apparatus 400)

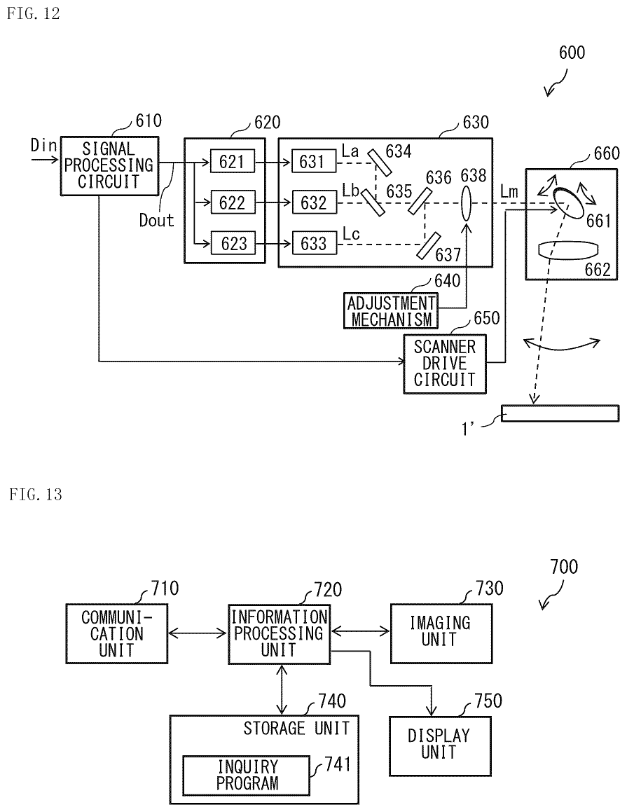

For example, as illustrated in FIG. 11, the inquiry/registration apparatus 400 includes a communication unit 410, an input unit 420, an information processing unit 430, a storage unit 440, and a display unit 450.

The communication unit 410 is a communication interface that is able to communicate with the collation apparatuses 100 and 200 via the communication network 800. The communication unit 410 is able to receive an inquiry request (C) for the individual identification information Dx from the information processing unit 430, and is able to transmit the received inquiry request (C) to the collation apparatus 100. The communication unit 410 is able to receive, from the inquiry apparatus 100, an inquiry result (e.g., the serial number Sx) (F) as a response to the inquiry request (C) for the individual identification information Dx, and is able to output the received inquiry result to the information processing unit 430. The communication unit 410 is able to receive a registration request for the meta information Mx and the serial number Sx from the information processing unit 430, and is able to transmit the received registration request (H) to the collation apparatus 200.

The input unit 420 is an interface including, for example, a touch panel, a keyboard, or the like. The input unit 420 is able to acquire, as the meta information Mx, text information (e.g., date of birth, address, nationality, etc. of a user) and image information (e.g., face photo) from the user, and is able to output the acquired pieces of information to the information processing unit 430.

The information processing unit 430 is configured by, for example, an MPU that performs registration and inquiry, or a CPU loaded with a drawing program 441, an inquiry program 442, and a registration program 443. The information processing unit 430 is able to acquire the meta information Mx from the input unit 420. The information processing unit 430 is able to acquire the image information Ix from the imaging apparatus 500. The information processing unit 430 is able to generate the feature information Cx having a smaller amount of data than that of the image information Ix by performing predetermined signal processing or encryption processing on the image information Ix. The information processing unit 430 is able to acquire, as the individual identification information Dx, the image information Ix or the feature information Cx corresponding to the image information Ix.

The information processing unit 430 is able to output an inquiry request for the individual identification information Dx to the communication unit 410. The information processing unit 430 is able to acquire, from the communication unit 410, an inquiry result (e.g., the serial number Sx) as a response to the inquiry request for the individual identification information Dx. The information processing unit 430 is able to output a registration request for the meta information Mx and the serial number Sx to the communication unit 410.

The information processing unit 430 is able to convert image data (e.g., face photo) included in the meta information Mx into leuco image data described in a leuco color space. Next, the information processing unit 430 is able to derive a voltage value file (a command voltage value list) on the basis of gradation values of respective colors of each drawing coordinate of the leuco image data obtained by the conversion. The information processing unit 430 is able to transmit the derived voltage value file (command voltage value list) to the drawing apparatus 600.

The storage unit 440 is configured by, for example, a volatile memory such as a DRAM, a non-volatile memory such as an EEPROM or a flash memory, or a recording apparatus such as an HDD, an optical disk drive, or a magnetic tape apparatus. The storage unit 440 stores, for example, the drawing program 441, the inquiry program 442, and the registration program 443.

The drawing program 441 is a program in which a series of procedures for transmitting image information (e.g., face photo) included in the meta information Mx to the drawing apparatus 600 is described. The inquiry program 442 is a program in which a series of procedures of inquiry performed in the inquiry/registration apparatus 400 is described. The registration program 443 is a program in which a series of procedures of registration performed in the inquiry/registration apparatus 400 is described.

The imaging apparatus 500 includes a CMOS image sensor, for example. The imaging apparatus 500 may further include, for example, a flash illumination, an ultraviolet illumination, an infra-red illumination, a polarization optical system, a magnifying lens, and the like, in order to efficiently detect a physical feature of the identification region 1A. In accordance with an instruction from the inquiry/registration apparatus 400, the imaging apparatus 500 is able to perform imaging with a CMOS image sensor, and is able to output the resulting image information Ix to the inquiry/registration apparatus 400 (information processing unit 430).

### (Drawing Apparatus 600)

For example, as illustrated in FIG. 12, the drawing apparatus 600 includes a signal processing circuit 610, a laser drive circuit 620, a light source unit 630, an adjustment mechanism 640, a scanner drive circuit 650, and a scanner unit 660. The drawing apparatus 600 is able to control an output of the light source unit 630 on the basis of the voltage value file (command voltage value list) inputted from the inquiry/registration apparatus 400 to thereby execute drawing on the identification element 1′.

The signal processing circuit 610 is able to acquire, as an image signal Din, a voltage value file (command voltage value list) inputted from the information processing unit 160. For example, the signal processing circuit 610 is able to generate, from the image signal Din, a pixel signal Dout corresponding to a scanning operation of the scanner unit 660. The pixel signal Dout causes the light source unit 630 (e.g., light sources 631, 632, and 633 described later) to output laser light of power corresponding to the command voltage value. The signal processing circuit 610, together with the laser drive circuit 620, is able to control a crest value of a current applied to the light source unit 630 (e.g., light sources 631, 632, and 633) in accordance with the pixel signal Dout.

For example, the laser drive circuit 620 is able to drive the light sources 631, 632, and 633 of the light source unit 630 in accordance with the pixel signal Dout. For example, the laser drive circuit 620 is able to control luminance (brightness/darkness) of the laser light in order to draw an image corresponding to the pixel signal Dout. The laser drive circuit 620 includes, for example, a drive circuit 621 that drives the light source 631, a drive circuit 622 that drives the light source 632, and a drive circuit 623 that drives the light source 633. The light sources 631, 632, and 633 are each able to output laser light of power corresponding to the command voltage value to the identification element 1′ to thereby execute drawing on the identification element 1′. The light sources 631, 632, and 633 are each able to emit laser light in a near-infrared region. The light source 631 is, for example, a semiconductor laser that emits laser light La of an emission wavelength λ1. The light source 632 is, for example, a semiconductor laser that emits laser light Lb of an emission wavelength λ2. The light source 633 is, for example, a semiconductor laser that emits laser light Lc of an emission wavelength λ3.

The light source unit 630 includes a plurality of light sources (e.g., three light sources 631, 632, and 633) having different emission wavelengths in the near-infrared region. Each of the light sources (e.g., each of the light sources 631, 632, and 633) is able to generate laser light having a wavelength corresponding to a light-absorbing wavelength range of a photothermal converting agent (described later) included in the identification element 1′. The light source unit 630 further includes, for example, an optical system that multiplexes a plurality of laser light beams (e.g., three laser light beams La, Lb, and Lc) emitted from a plurality of light sources (e.g., three light sources 631, 632, and 633). As used herein, the term “multiplex” means scanning a plurality of laser light beams using one galvano. For example, this optical system is able to output multiplexed light (laser light Lm) of the plurality of laser light beams La, Lb, and Lc to the scanner unit 660 to allow a plurality of irradiation spots, which is generated on the identification element 1′ by the plurality of laser light beams La, Lb, and Lc, not to overlap each other on the identification element 1′. For example, the light source unit 630 includes, as such an optical system, two reflective mirrors 634 and 637, two dichroic mirrors 635 and 636, and a lens 638.

The laser light beams La and Lb emitted from the two light sources 631 and 632 are converted into substantially parallel light (collimated light) by a collimating lens, for example. Thereafter, for example, the laser light La is reflected by the reflective mirror 634 and reflected by the dichroic mirror 635, and the laser light Lb is transmitted through the dichroic mirror 635. This allows the laser light La and the laser light Lb to be multiplexed. The multiplexed light of the laser light La and the laser light Lb is transmitted through the dichroic mirror 636.

The laser light Lc emitted from the light source 633 is converted into substantially parallel light (collimated light) by a collimating lens, for example. Thereafter, for example, the laser light Lc is reflected by the reflective mirror 637 and reflected by the dichroic mirror 636. This allows the above-described multiplexed light transmitted through the dichroic mirror 636 and the laser light Lc reflected by the dichroic mirror 636 to be multiplexed. For example, the light source unit 630 is able to output, to the scanner unit 660, light (laser light Lm) obtained by the above-described multiplexing by the optical system.

The adjustment mechanism 640 is a mechanism to adjust focusing of the multiplexed light Lm emitted from the light source unit 630. The adjustment mechanism 640 is, for example, a mechanism that is able to adjust a position of the lens 638 by a manual operation of a user. It is to be noted that the adjustment mechanism 640 may be a mechanism that is able to adjust the position of the lens 638 by a mechanical operation.

The scanner drive circuit 650 is able to drive the scanner unit 660 on the basis of a control signal inputted from the signal processing circuit 610, for example. In addition, in a case where a signal of an irradiation angle of a biaxial scanner 661 described later is inputted from the scanner unit 660, for example, the scanner drive circuit 650 is able to drive, on the basis of the signal, the scanner unit 660 to obtain a desired irradiation angle.

For example, the scanner unit 660 is able to cause the multiplexed light Lm incident from the light source unit 630 to perform raster scanning on a surface of the identification element 1′. The scanner unit 660 includes, for example, the biaxial scanner 661 and an fθ lens 662. The biaxial scanner 661 is a galvano mirror, for example. The fθ lens 662 converts a uniform rotary motion by the biaxial scanner 661 into a uniform linear motion of a spot moving on a focal plane (surface of the identification element 1′). It is to be noted that the scanner unit 660 may be configured by a uniaxial scanner and the fθ lens. In this case, a uniaxial stage is preferably provided, which displace the identification element 1′ in a direction orthogonal to a scanning direction of the uniaxial scanner.

[Method of Recording into Identification Element 1′]

Next, description is given, with reference to FIGS. 7 and 12, of an example of a method of recording into the identification element 1′.

First, the user prepares the identification element 1′ which is uncolored and places the prepared identification element 1′ on the drawing apparatus 600. Next, the user inputs the input image data described in an RGB color space into the inquiry/registration apparatus 400. When acquiring the inputted image data, the inquiry/registration apparatus 400 executes the following recording process.

First, the inquiry/registration apparatus 400 converts the inputted image data described in the RGB color space into leuco image data described in the leuco color space. Next, the inquiry/registration apparatus 400 derives a voltage value file (command voltage value list) on the basis of gradation values of respective colors of each drawing coordinate of the leuco image data acquired by the conversion. The inquiry/registration apparatus 400 transmits the derived voltage value file (command voltage value list) to the drawing apparatus 600.

The signal processing circuit 610 of the drawing apparatus 600 acquires, as the image signal Din, the voltage value file (command voltage value list) inputted from the inquiry/registration apparatus 400. The signal processing circuit 610 generates, from the image signal Din, an image signal corresponding to characteristics such as a wavelength of laser light, in synchronization with a scanning operation of the scanner unit 660. In the generated image signal, the signal processing circuit 610 converts the image signal for one line corresponding to one scanning operation into a continuous signal that causes the laser light to be outputted continuously over time. The signal processing circuit 610 outputs a projected image signal thus generated to the laser drive circuit 620. The projected image signal is a signal that causes the light sources 631, 632, and 633 to continuously output laser light for one line over time or intermittently.

The laser drive circuit 620 drives the light sources 631, 632, and 633 of the light source unit 630 in accordance with projected picture signals corresponding to respective wavelengths. At this time, the laser drive circuit 620 causes at least one of the light source 631, the light source 632, or the light source 633, for example, to emit laser light to perform scanning on the identification element 1′ (thermosensitive recording layer 40A).

For example, in FIG. 4, in a case where the recording layer 43 is colored, the recording layer 43 is irradiated with the laser light La of the emission wavelength λ1 with energy to such an extent as to cause the recording layer 43 to reach a coloring temperature. This causes the photothermal converting agent included in the recording layer 43 to generate heat, and a coloring reaction (chromogenic reaction) occurs between the color-forming compound and the color-developing/reducing agent, thus allowing a magenta color, for example, to be developed in the irradiated part. Likewise, in a case where the recording layer 45 is colored, the recording layer 45 is irradiated with the laser light Lb of the emission wavelength λ2 with energy to such an extent as to cause the recording layer 45 to reach a coloring temperature, thereby causing a cyan color, for example, to be developed in the irradiated part. In a case where the recording layer 47 is colored, the recording layer 47 is irradiated with the laser light Lc of the emission wavelength λ3 with energy to such an extent as to cause the recording layer 47 to reach a coloring temperature, thereby causing a yellow color, for example, to be developed in the irradiated part. In this manner, irradiating any part with laser light of a corresponding wavelength enables recording of a design or the like (e.g., a full-color design, etc.).

### (Inquiry Apparatus 700)

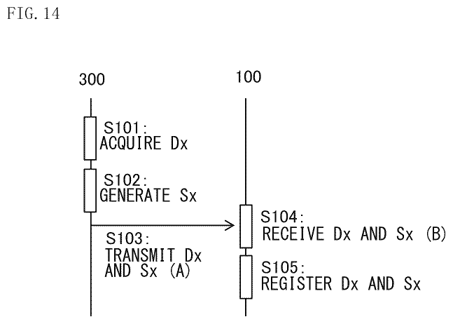

For example, as illustrated in FIG. 13, the inquiry apparatus 700 includes a communication unit 710, an information processing unit 720, an imaging unit 730, a storage unit 740, and a display unit 750.

The communication unit 710 is a communication interface that is able to communicate with the inquiry apparatuses 100 and 200 via the communication network 800. The communication unit 710 is able to transmit an inquiry request (J) for the individual identification information Dx to the inquiry apparatus 100. The communication unit 710 is able to receive, from the collation apparatus 100, the inquiry result (M) as a response to the inquiry request (J) for the individual identification information Dx. The communication unit 710 is able to transmit, to the inquiry apparatus 200, an inquiry request (N) for the serial number Sx acquired as an inquiry result from the collation apparatus 100. The communication unit 710 is able to receive, from the inquiry apparatus 200, the inquiry result (Q) as a response to the inquiry request (N) for the serial number Sx.

The information processing unit 720 is configured by, for example, an MPU that performs registration and collation, or a CPU loaded with a collation program 741. The information processing unit 720 is able to acquire the image information Ix from the imaging unit 730. The information processing unit 720 is able to generate the feature information Cx having a smaller amount of data than that of the image information Ix by performing predetermined signal processing or encryption processing on the image information Ix. The information processing unit 720 is able to acquire, as the individual identification information Dx, the image information Ix or the feature information Cx corresponding to the image information Ix.

The information processing unit 720 is able to output an inquiry request for the individual identification information Dx to the communication unit 710. The signal processing unit 720 is able to acquire, from the communication unit 710, an inquiry result (e.g., the serial number Sx) as a response to the inquiry request for the individual identification information Dx. The signal processing unit 720 is able to output an inquiry request for the serial number Sx to the communication unit 710. The signal processing unit 720 is able to acquire, from the communication unit 710, an inquiry result (e.g., the meta information Mx) as a response to the inquiry request for the serial number Sx.

The imaging unit 730 includes a CMOS image sensor, for example. The imaging apparatus 730 may further include, for example, a flash illumination, an ultraviolet illumination, an infra-red illumination, a polarization optical system, a magnifying lens, and the like, in order to efficiently detect a physical feature of the identification region 1A. In accordance with an instruction from the information processing unit 720, the imaging unit 730 is able to perform imaging with a CMOS image sensor, and is able to output the resulting image information Ix to the information processing unit 720.

The storage unit 740 is configured by, for example, a volatile memory such as a DRAM, a non-volatile memory such as an EEPROM or a flash memory, or a recording apparatus such as an HDD, an optical disk drive, or a magnetic tape apparatus. The storage unit 740 stores, for example, the inquiry program 741.

The display unit 750 includes, for example, a liquid crystal panel or an organic EL panel. The display unit 750 is able to display a picture based on a picture signal outputted from the information processing unit 720.

### [Registration of Individual Identification Information Dx and Serial Number Sx]

Next, description is given of an example of a registration method of the individual identification information Dx and the serial number Sx in the collation apparatus 100.

FIG. 14 illustrates an example of a procedure for registering the individual identification information Dx and the serial number Sx in the authentication system of FIG. 7. First, the registration apparatus 300 acquires the individual identification information Dx from the identification region 1A of the identification element 1′ by imaging by the imaging unit 330 (step S101). Next, the registration apparatus 300 generates the serial number Sx corresponding to the individual identification information Dx (step S102). Subsequently, the registration apparatus 300 transmits the individual identification information Dx and the serial number Sx to the collation apparatus 100 (step S103).

The collation apparatus 100 receives the individual identification information Dx and the serial number Sx from the registration apparatus 300 (step S104). Subsequently, the collation apparatus 100 registers the received individual identification information Dx and the received serial number Sx in the corresponding table 131 of the storage unit 130 (step S105). In this manner, the individual identification information Dx and the serial number Sx are registered in the collation apparatus 100.

### [Registration of Meta Information Mx and Serial Number Sx]

Next, description is given of an example of a registration method of the meta information Mx and the serial number Sx in the collation apparatus 200.

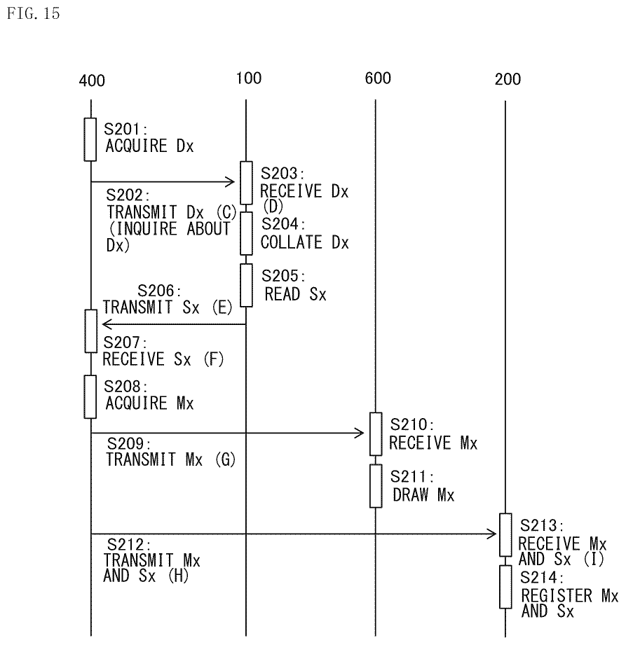

FIG. 15 illustrates an example of a procedure for registering the meta information Mx and the serial number Sx in the authentication system of FIG. 7. First, the inquiry/registration apparatus 400 instructs the imaging apparatus 500 to perform imaging, and acquires the image information Ix from the imaging apparatus 500. Next, the inquiry/registration apparatus 400 generates the feature information Cx by performing predetermined signal processing or encryption processing on the acquired image information Ix. The inquiry/registration apparatus 400 acquires, as the individual identification information Dx, the image information Ix or the feature information Cx corresponding to the image information Ix (step S201). The inquiry/registration apparatus 400 transmits an inquiry request for the acquired individual identification information Dx to the collation apparatus 100 (step S202).

The collation apparatus 100 receives an inquiry request for the individual identification information Dx from the inquiry/registration apparatus 400 (step S203). The collation apparatus 100 collates the received individual identification information Dx and each piece of individual identification information registered in the corresponding table 131 of the storage unit 130 with each other (step S204). When the collation is successful, the collation apparatus 100 reads the serial number Sx corresponding to the individual identification information Dx from the corresponding table 131, and transmits the read serial number Sx as an inquiry result to the inquiry/registration apparatus 400 (Steps S205 and S206).

The inquiry/registration apparatus 400 receives, from the collation apparatus 100, an inquiry result (serial number Sx) as a response to the inquiry request for the individual identification information Dx (step S207). The inquiry/registration apparatus 400 acquires the meta information Mx by a user input (step S208). The inquiry/registration apparatus 400 converts image data (e.g., face photo) of the acquired meta information Mx into leuco image data described in the leuco color space. The inquiry/registration apparatus 400 derives a voltage value file (command voltage value list) on the basis of gradation values of respective colors of each drawing coordinate of the leuco image data acquired by the conversion. The inquiry/registration apparatus 400 transmits the derived voltage value file (command voltage value list) to the drawing apparatus 600 (step S209).

The drawing apparatus 600 receives image data (e.g., face photo) of the meta information Mx as the voltage value file (command voltage value list) from the inquiry/registration apparatus 400 (step S210). The drawing apparatus 600 performs drawing on the thermosensitive recording layer 40A of the identification element 1′ on the basis of the received voltage value file (command voltage value list) (step S211).

The inquiry/registration apparatus 400 transmits a registration request for the meta information Mx and the serial number Sx to the collation apparatus 200 (step S212). The collation apparatus 200 receives a registration request for the meta information Mx and the serial number Sx from the inquiry/registration apparatus 400 (step S213). The collation apparatus 200 registers the received meta information Mx and the received serial number Sx in the corresponding table 231 of the storage unit 23 (step S214). In this manner, the meta information Mx and the serial number Sx are registered in the collation apparatus 200.

### [Collation of Individual Identification Information Dx and Serial Number Sx]

Next, description is given of an example of a collation method of the individual identification information Dx and the serial number Sx in the collation apparatuses 100 and 200.

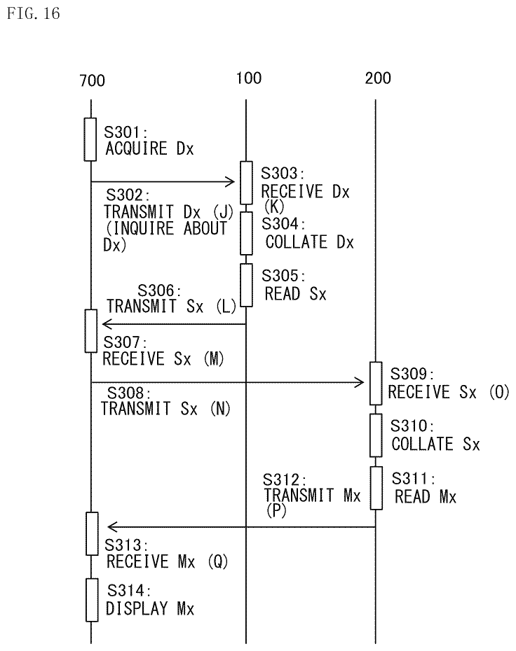

FIG. 16 illustrates an example of a procedure for collating the individual identification information Dx and the serial number Sx in the authentication system of FIG. 7. First, the inquiry apparatus 700 acquires the image information Ix from the identification region 1A of the identification element 1 by imaging by the imaging unit 730. Next, the inquiry apparatus 700 generates the feature information Cx by performing predetermined signal processing or encryption processing on the image information Ix. The inquiry apparatus 700 acquires, as the individual identification information Dx, the image information Ix or the feature information Cx corresponding to the image information Ix (step S301). The inquiry apparatus 700 transmits an inquiry request for the individual identification information Dx to the collation apparatus 100 (step S302).

The collation apparatus 100 receives the inquiry request for the individual identification information Dx from the inquiry apparatus 700 (step S303). Next, the collation apparatus 100 collates the received individual identification information Dx and each piece of individual identification information registered in the corresponding table 131 of the storage unit 130 with each other (step S304). When the collation is successful, the collation apparatus 100 reads the serial number Sx corresponding to the individual identification information Dx from the corresponding table 131, and transmits the read serial number Sx as an inquiry result to the inquiry apparatus 700 (steps S305 and S306).

The inquiry apparatus 700 receives the inquiry result (serial number Sx) as a response to the inquiry request for the individual identification information Dx (step S307). The inquiry apparatus 700 transmits an inquiry request for the serial number Sx to the collation apparatus 200 (step S308).

The collation apparatus 200 receives the inquiry request for the serial number Sx from the inquiry apparatus 700 (step S309). Next, the collation apparatus 200 collates the received serial number Sx and each of serial numbers registered in the corresponding table 231 of the storage unit 230 with each other (step S310). When the collation is successful, the collation apparatus 200 reads the meta information Mx corresponding to the serial number Sx from the corresponding table 231, and transmits the read meta information Mx as an inquiry result to the inquiry apparatus 700 (steps S311 and S312).

The inquiry apparatus 700 receives the meta information Mx as a response to the inquiry request for the serial number Sx (step S313). The inquiry apparatus 700 displays a picture including the received meta information Mx. In this manner, the collation of the individual identification information Dx and the serial number Sx in the collation apparatuses 100 and 200 is performed.

### [Effects]

Next, description is given of effects of the identification element 1 and the inquiry apparatus 700 according to the present embodiment.

In recent years, technologies have been developed to improve an anti-counterfeit property of a card such as a security card, a financial payment card (e.g., a credit card, a cash card, etc.), an ID card (e.g., a passport, an entry/exit card, an employee ID card, a membership card, a student ID card, etc.), or an individual transaction card (e.g., a prepaid card, a point card, etc.). In addition, technologies have also been developed to improve safety of authentication in an authentication system using the above-mentioned card. Incidentally, the card as described above is required to improve the anti-counterfeit property without impairing its appearance. In addition, it is required to improve safety of authentication in a simple manner.

Meanwhile, the identification element 1 according to the present embodiment is provided with the thermosensitive recording medium 20 in which one or a plurality of layers is provided on the support substrate 10, and the identification region 1A having a unique physical feature is provided in at least a portion of the thermosensitive recording medium 20. Here, unlike a two-dimensional bar code, a hologram, or the like, for example, which has a poor anti-counterfeit property and is highly likely to impair the appearance, the identification region 1A has a unique physical feature of a superior anti-counterfeit property and of being unlikely to impair the appearance. In addition, it is possible for the identification region 1A to be formed in a relatively simple manner, as compared with the two-dimensional bar code, the hologram, or the like, for example. It is therefore possible to improve the anti-counterfeit property without impairing the appearance. In addition, it is possible to improve safety of authentication in a simple manner.

In the identification element 1 according to the present embodiment, at least one layer of the one or the plurality of layers included in the thermosensitive recording medium 20 is provided with the recording layer 43, the recording layer 45, or the recording layer 47. This makes it possible to improve safety of authentication.

In the identification element 1 according to the present embodiment, the identification region 1A is disposed at a location, on the support substrate 10, that differs from one or a plurality of thermosensitive recording layers (at least one layer of the recording layer 43, the recording layer 45, and the recording layer 47), in a plan view. Accordingly, when laser irradiation is performed on the one or the plurality of thermosensitive recording layers, it is possible to reduce the possibility that the laser irradiation may influence the identification region 1A (e.g., degradation, deformation, or the like of the identification region 1A due to heat generated by the laser irradiation). As a result, it is possible to reduce the possibility that the unique physical feature included in the identification region 1A may vary in the process of performing the laser irradiation on the one or the plurality of thermosensitive recording layers.

In the identification element 1 according to the present embodiment, the identification region 1A is disposed at a location, on the support substrate 10, that differs from one or a plurality of thermosensitive recording layers (at least one layer of the recording layer 43, the recording layer 45, and the recording layer 47), in a side view. Accordingly, when laser irradiation is performed on the one or the plurality of thermosensitive recording layers, it is possible to reduce the possibility that the laser irradiation may influence the identification region 1A (e.g., degradation, deformation, or the like of the identification region 1A due to heat generated by the laser irradiation). As a result, it is possible to reduce the possibility that the unique physical feature included in the identification region 1A may vary in the process of performing the laser irradiation on the one or the plurality of thermosensitive recording layers.

In the identification element 1 according to the present embodiment, the outermost layer (cover layer 22) in one or a plurality of layers included in the thermosensitive recording medium 20 is provided to cover the one or the plurality of thermosensitive recording layers (at least one layer of the recording layer 43, the recording layer 45, and the recording layer 47). This makes it possible to improve the anti-counterfeit property of each of the recording layer 43, the recording layer 45, and the recording layer 47.

In the identification element 1 according to the present embodiment, an embedding structure that enables the one or the plurality of thermosensitive recording layers (at least one layer of the recording layer 43, the recording layer 45, and the recording layer 47) to be embedded is provided at a location other than the outermost layer (cover layer 22) among the one or the plurality of layers included in the thermosensitive recording medium 20. Further, the one or the plurality of thermosensitive recording layers (at least one layer of the recording layer 43, the recording layer 45, and the recording layer 47) is embedded in the embedding structure. This enables formation of the outermost layer (cover layer 22) in the one or the plurality of layers included in the thermosensitive recording medium 20 to have a planarized surface, thus making it possible to improve the anti-counterfeit property of each of the recording layer 43, the recording layer 45, and the recording layer 47 without impairing appearance of the identification element 1.

In the identification element 1 according to the present embodiment, the identification region 1A is a region in which retroreflective particles, phosphor particles, birefringent particles, infrared-absorbing particles, or glass beads are distributed. That is, unlike a two-dimensional bar code, a hologram, or the like, for example, which has a poor anti-counterfeit property and is highly likely to impair the appearance, the identification region 1A has a unique physical feature of a superior anti-counterfeit property due to its difficulty in reproduction of the above-described dispersion state of the particles, and of being unlikely to impair the appearance due to its invisibility to the naked eyes under normal illumination. In addition, it is possible for the identification region 1A to be formed in a relatively simple manner, as compared with the two-dimensional bar code, the hologram, or the like, for example. It is therefore possible to improve the anti-counterfeit property without impairing the appearance. In addition, it is possible to improve safety of authentication in a simple manner.

In the identification element 1 according to the present embodiment, the thermosensitive recording layer 40 is thermosensitively colored. It is possible to improve safety of authentication by utilizing coloration of the thermosensitive recording layer 40.

In the inquiry apparatus 700 according to the present embodiment, the image information Ix or the feature information Cx corresponding to the image information Ix is detected as the individual identification information Dx from the identification region 1A of the identification element 1. This makes it possible to inquire of the inquiry apparatus 100 about the individual identification information Dx to acquire an inquiry result from the inquiry apparatus 100. Here, unlike a two-dimensional bar code, a hologram, or the like, for example, which has a poor anti-counterfeit property and is highly likely to impair the appearance, the identification region 1A has a unique physical feature of a superior anti-counterfeit property due to its difficulty in reproduction of the dispersion state of the particles, and of being unlikely to impair the appearance due to its invisibility to the naked eyes under normal illumination. In addition, it is possible for the identification region 1A to be formed in a relatively simple manner, as compared with the two-dimensional bar code, the hologram, or the like, for example. It is therefore possible to improve the anti-counterfeit property without impairing the appearance. In addition, it is possible to improve safety of authentication in a simple manner.

In the inquiry apparatus 700 according to the present embodiment, in a case where the serial number Sx is acquired as an inquiry result, the acquired serial number Sx is inquired of the collation apparatus 200, and an inquiry result (meta information Mx) is acquired from the collation apparatus 200. In such a case, when the inquiry apparatus 100 and the inquiry apparatus 200 are administered by different administrators, the administrator of the inquiry apparatus 100 is kept from being in contact with the meta information Mx corresponding to personal information. It is therefore unnecessary to take measures to protect the personal information for the inquiry apparatus 100.

In the inquiry apparatus 700 according to the present embodiment, the meta information Mx is displayed. This enables a user of the inquiry apparatus 700, for example, to authenticate a user of the identification element 1 while causing the display unit 750 of the inquiry apparatus 700 to display the meta information Mx.

### 2. Modification Examples of First Embodiment

Next, description is given of modification examples of the identification element 1 according to the first embodiment. Hereinafter, description is given mainly of a configuration that differs from that of the first embodiment.

### Modification Example 1-1

FIG. 17 illustrates a modification example of the schematic configuration of the authentication system of FIG. 7. In the foregoing embodiment, a collation apparatus 900 may be provided instead of the collation apparatuses 100 and 200, and the registration apparatus 300 may be omitted. In the present modification example, the individual identification information Dx and the meta information Mx are associated with each other in the collation apparatus 900, and collation utilizing the individual identification information Dx is performed. Accordingly, in the present modification example, the collation utilizing the serial number Sx is not performed. Hereinafter, detailed description is given of a configuration of the collation apparatus 900 and collation in the collation apparatus 900.

When the individual identification information Dx and the meta information Mx are inputted as registration information (C) from the inquiry/registration apparatus 400, the collation apparatus 900 is able to register the inputted registration information in a storage unit 930 (described later) of the collation apparatus 900. The collation apparatus 900 is an apparatus that, when an inquiry about the individual identification information Dx (E) is requested from the inquiry apparatus 700, is able to collate the requested individual identification information Dx and already registered individual identification information with each other. The collation apparatus 900 is able to transmit a collation result as the inquiry result (F) to the requested apparatus (inquiry apparatus 700). When the collation is successful, the collation apparatus 900 is able to output, as an inquiry result, the meta information Mx corresponding to the individual identification information Dx.

In the present modification example, the inquiry/registration apparatus 400 is able to transmit the acquired individual identification information Dx and the acquired meta information Mx to the collation apparatus 900 for registration thereof in the collation apparatus 900. In the present modification example, the inquiry apparatus 700 is able to inquire of the collation apparatus 900 about the acquired individual identification information Dx to acquire an inquiry result thereof from the collation apparatus 900. The inquiry apparatus 700 is able to display the inquiry result acquired from the collation apparatus 900.

### (Collation Apparatus 900)

For example, as illustrated in FIG. 18, the collation apparatus 900 includes a communication unit 910, an information processing unit 920, and a storage unit 930.

The communication unit 910 is a communication interface that is able to communicate with the inquiry/registration apparatus 400 and the inquiry apparatus 700 via the communication network 800. The communication unit 910 is able to receive a registration request (C) for the individual identification information Dx and the meta information Mx from the registration apparatus 300, and is able to output the received registration request (C) to the information processing unit 920. The communication unit 910 is able to receive an inquiry request (E) for the individual identification information Dx from the inquiry apparatus 700, and is able to output the received inquiry request (E) to the information processing unit 920. The communication unit 910 is able to output, to a request source (inquiry apparatus 700), an inquiry result (e.g., the meta information Mx) (F) as a response to the inquiry request (E) for the individual identification information Dx (E).

The information processing unit 920 is configured by, for example, an MPU that performs registration and collation, or a CPU loaded with a registration program 932 and a collation program 933. When acquiring the registration request for the individual identification information Dx and the meta information Mx, the information processing unit 920 is able to store the individual identification information Dx and the meta information Mx included in the acquired registration request in a corresponding table 931 of the storage unit 930.

When acquiring the inquiry request for the individual identification information Dx, the information processing unit 920 is able to collate the individual identification information Dx included in the acquired inquiry request. The information processing unit 920 is able to compare the individual identification information Dx included in the acquired inquiry request and a plurality of pieces of individual identification information Di (1≤i≤n; n is a positive integer) included in the corresponding table 931 with each other to determine whether or not the individual identification information Dx coincides with one of the plurality of pieces of individual identification information Di included in the corresponding table 931. In a case where the individual identification information Dx coincides with the individual identification information Di included in the corresponding table 931, the information processing unit 920 is able to read the meta information Mi corresponding to the individual identification information Di from the corresponding table 931 to set the read meta information Mi as the meta information Mx corresponding to the individual identification information Dx. At this time, the information processing unit 920 is able to output the meta information Mx as an inquiry result. In a case where the individual identification information Dx does not coincide with any of the plurality of pieces of individual identification information Di included in the corresponding table 931, the information processing unit 920 is able to output, as an inquiry result, information indicating that no collation has been made (e.g., information not including the meta information Mx).

The storage unit 930 is configured by, for example, a volatile memory such as a DRAM, a non-volatile memory such as an EEPROM or a flash memory, or a recording apparatus such as an HDD, an optical disk drive, or a magnetic tape apparatus. The storage unit 930 stores, for example, the corresponding table 931, the registration program 932, and the collation program 933.

The corresponding table 931 stores the individual identification information Di and the meta information Mi in association with each other. The corresponding table 931 stores a plurality of sets of individual identification information Di and meta information Mi. The registration program 932 is a program in which a series of procedures of registration performed in the collation apparatus 900 is described. The collation program 933 is a program in which a series of procedures of collation performed in the collation apparatus 1900 is described.

### (Inquiry/Registration Apparatus 400)

The communication unit 410 is a communication interface that is able to communicate with an inquiry apparatus 900 via the communication network 800. The communication unit 410 is able to receive a registration request for the individual identification information Dx and the meta information Mx from the information processing unit 430, and is able to transmit the received registration request (B) to the collation apparatus 900. The information processing unit 430 is able to output the registration request for the individual identification information Dx and the meta information Mx to the communication unit 410.

### (Inquiry Apparatus 700)

The communication unit 710 is a communication interface that is able to communicate with the inquiry apparatus 900 via the communication network 800. The communication unit 710 is able to transmit an inquiry request for the individual identification information Dx to the inquiry apparatus 900. The communication unit 710 is able to receive, from the collation apparatus 900, an inquiry result as a response to the inquiry request for the individual identification information Dx.

### [Registration of Individual Identification Information Dx and Meta Information Mx]

Next, description is given of an example of a registration method of the individual identification information Dx and the meta information Mx in the collation apparatus 900.

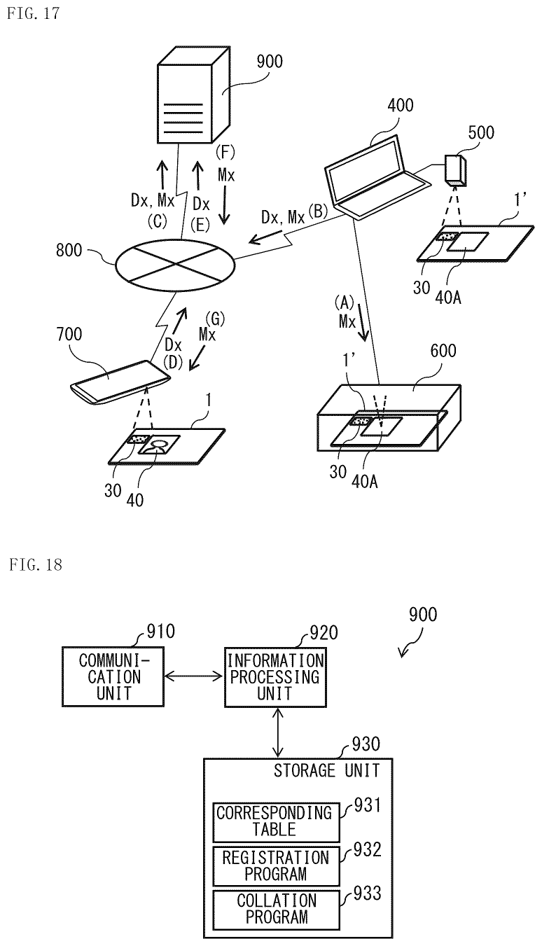

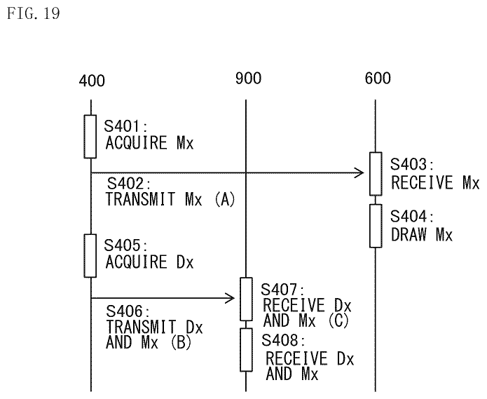

FIG. 19 illustrates an example of a procedure for registering the individual identification information Dx and the meta information Mx in the authentication system of FIG. 17. First, the inquiry/registration apparatus 400 acquires the meta information Mx by a user input (step S401). The inquiry/registration apparatus 400 converts image data (e.g., face photo) of the acquired meta information Mx into leuco image data described in the leuco color space. The inquiry/registration apparatus 400 derives a voltage value file (command voltage value list) on the basis of gradation values of respective colors of each drawing coordinate of the leuco image data acquired by the conversion. The inquiry/registration apparatus 400 transmits the derived voltage value file (command voltage value list) to the drawing apparatus 600 (step S402).

The drawing apparatus 600 receives image data (e.g., face photo) of the meta information Mx as the voltage value file (command voltage value list) from the inquiry/registration apparatus 400 (step S403). The drawing apparatus 600 performs drawing on the thermosensitive recording layer 40A of the identification element 1′ on the basis of the received voltage value file (command voltage value list) (step S404).

First, the inquiry/registration apparatus 400 instructs the imaging apparatus 500 to perform imaging, and acquires the image information Ix from the imaging apparatus 500. Next, the inquiry/registration apparatus 400 generates the feature information Cx by performing predetermined signal processing or encryption processing on the acquired image information Ix. The inquiry/registration apparatus 400 acquires, as the individual identification information Dx, the image information Ix or the feature information Cx corresponding to the image information Ix (step S405).

The inquiry/registration apparatus 400 transmits a registration request for the individual identification information Dx and the meta information Mx to the collation apparatus 900 (step S406). The collation apparatus 900 receives the registration request for the individual identification information Dx and the meta information Mx from the inquiry/registration apparatus 400 (step S407). The collation apparatus 900 registers the received individual identification information Dx and the received meta information Mx in the corresponding table 931 of the storage unit 93 (step S408). In this manner, the individual identification information Dx and the meta information Mx are registered in the collation apparatus 900.

### [Collation of Individual Identification Information Dx]

Next, description is given of an example of a collation method of the individual identification information Dx in the collation apparatus 900.

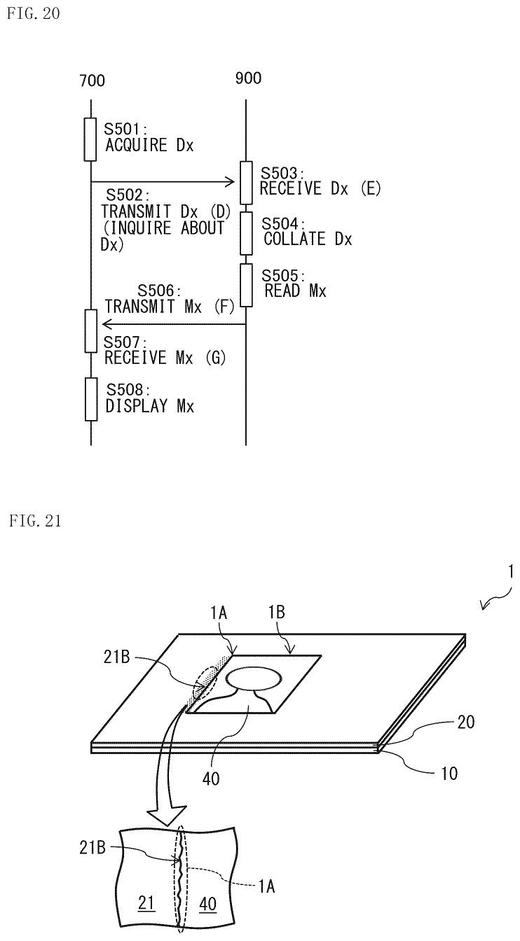

FIG. 20 illustrates an example of a procedure for collating the individual identification information Dx in the authentication system of FIG. 17. First, the inquiry apparatus 700 acquires the image information Ix from the identification region 1A of the identification element 1 by imaging by the imaging unit 730. Next, the inquiry apparatus 700 generates the feature information Cx by performing predetermined signal processing or encryption processing on the image information Ix. The inquiry apparatus 700 acquires, as the individual identification information Dx, the image information Ix or the feature information Cx corresponding to the image information Ix (step S501). The inquiry apparatus 700 transmits an inquiry request for the individual identification information Dx to the collation apparatus 900 (step S502).

The collation apparatus 900 receives the inquiry request for the individual identification information Dx from the inquiry apparatus 700 (step S503). Next, the collation apparatus 900 collates the received individual identification information Dx and each piece of individual identification information registered in the corresponding table 931 of the storage unit 930 with each other (step S504). When the collation is successful, the collation apparatus 900 reads the meta information Mx corresponding to the individual identification information Dx from the corresponding table 931, and transmits the read meta information Mx as an inquiry result to the inquiry apparatus 700 (steps S505 and S506).

The inquiry apparatus 700 receives an inquiry result (meta information Mx) as a response to the inquiry request for the individual identification information Dx (step S507). The inquiry apparatus 700 displays a picture including the received meta information Mx (step S508). In this manner, the collation of the individual identification information Dx in the collation apparatus 900 is performed.

In the present modification example, the acquired individual identification information Dx is inquired of the collation apparatus 900, and the inquiry result (meta information Mx) is acquired from the collation apparatus 900. In such a case, it is possible to cause one collation apparatus 900 to perform a collation operation in the authentication system of FIG. 17, thus making it possible to simplify the configuration of the authentication system of FIG. 17.

In the present modification example, the meta information Mx is displayed in the inquiry apparatus 700. This enables a user of the inquiry apparatus 700, for example, to authenticate a user of the identification element 1 while causing the display unit 750 of the inquiry apparatus 700 to display the meta information Mx.

### Modification Example 1-2

FIG. 21 illustrates a modification example of the perspective configuration of the identification element 1 according to the first embodiment. In the first embodiment, the identification region 1A (identification layer 30) may be, for example, a boundary line between the thermosensitive recording layer 40 and the through-hole part 21B of the embedded layer 21, in a plan view, as illustrated in FIG. 21. Here, in the above-described boundary line, there is waviness generated at the time when the through-hole part 21B is created for the embedded layer 21, for example, as illustrated in FIG. 21. This waviness corresponds to a unique physical feature, and specifically corresponds to a physical feature based on artifact metrics.

As described above, in the present modification example, the identification region 1A is a boundary line between the thermosensitive recording layer 40 and the through-hole part 21B of the embedded layer 21, in a plan view. This enables the identification region 1A to also serve as an existing structure (the above-described boundary line) of the identification element 1, thus making it possible to improve an anti-counterfeit property without impairing the appearance.

### Modification Example 1-3

FIG. 22 illustrates a modification example of the perspective configuration of the identification element 1 according to the first embodiment and the modification examples thereof. In the first embodiment and the modification examples thereof, the identification element 1 may further include a positioning mark 50 that is able to specify a position of the identification region 1A, for example, as illustrated in FIG. 22. The positioning mark 50 is provided around the identification region 1A, in a plan view.

Here, it is assumed that the identification element 1 is provided with an underlayer 11, for example, as illustrated in FIG. 23. The underlayer 11 is provided between the support substrate 10 and the embedded layer 21 (thermosensitive recording layer 20), and is in contact with a surface, of the support substrate 10, on a side of the embedded layer 21 (thermosensitive recording layer 20). The underlayer 11 is, for example, a printed layer formed by printing a pattern (e.g., a design, a graphic, a photograph, a letter, or a combination of two or more thereof) on the surface of the support substrate 10. At this time, the positioning mark 50 may be, for example, a pattern of the underlayer 11.

As described above, in the present modification example, the positioning mark 50 is provided. This enables, for example, users of the registration apparatus 300, the imaging apparatus 500, and the inquiry apparatus 700 to easily grasp an imaging region (a region including the identification region 1A (identification layer 30)) of the imaging apparatus, with the help of the positioning mark 50. As a result, it is possible to accurately capture an image of the identification region 1A (identification layer 30).

In addition, in the present modification example, in a case where the positioning mark 50 is a pattern of the underlayer 11, the positioning mark 50 is covered with the support substrate 10 and the embedded layer 21. This enables protection of the positioning mark 50, thus making it possible to improve an anti-counterfeit property of the positioning mark 50.

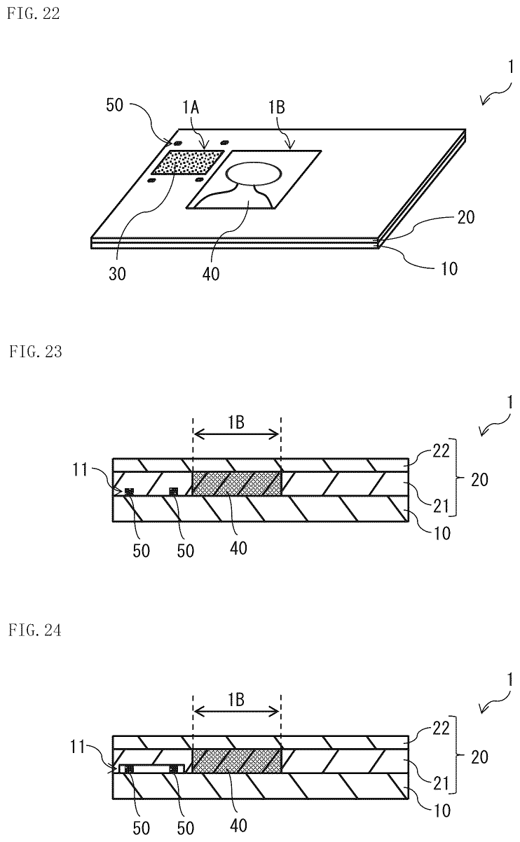

In the present modification example, the underlayer 11 may be a thermosensitive recording layer in which the positioning mark 50 is drawn, for example, as illustrated in FIG. 24. Here, the thermosensitive recording layer constituting the underlayer 11 is configured by, for example, a material common to that of the recording layer 43, the recording layer 45, or the recording layer 47. In such a case, irradiation of an undrawn underlayer 11′ with laser light enables formation of the underlayer 11 with the positioning mark 50 being drawn. At this time, for example, drawing the positioning mark 50 by using a position of the identification region 1A (identification layer 30) as a standard makes it possible to accurately draw the positioning mark 50 with respect to the identification region 1A (identification layer 30).

### 3. Second Embodiment

### [Configuration]

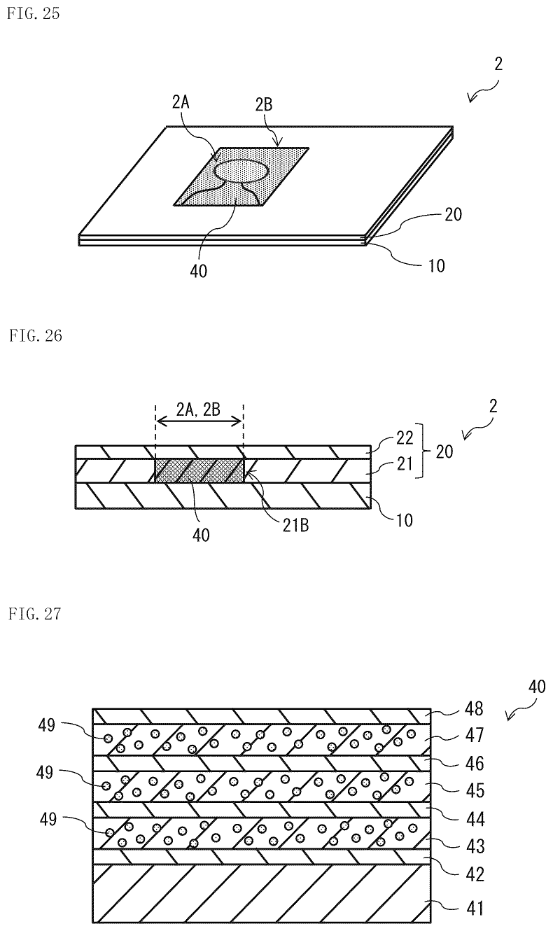

Next, description is given of an identification element 2 according to a second embodiment of the present disclosure. FIG. 25 illustrates an example of a perspective configuration of the identification element 2 according to the present embodiment. FIG. 26 illustrates an example of a cross-sectional configuration of the identification element 2 of FIG. 25. The identification element 2 is, for example, a recording medium that is usable for a use application similar to that of the identification element 1. It is possible to authenticate the identification element 2 using an authentication system similar to the authentication system that authenticates the identification element 1.

For example, as illustrated in FIGS. 25 and 26, the identification element 2 includes, on the support substrate 10, the thermosensitive recording medium 20 in which one or a plurality of layers is provided. The thermosensitive recording medium 20 is a plate-like recording medium having an identification region 2A and a thermosensitive recording region 2B. The thermosensitive recording layer 40 is disposed in the thermosensitive recording region 2B, and the identification region 2A is a portion of the thermosensitive recording region 2B (thermosensitive recording layer 40). The identification region 2A is disposed, on the support substrate 10, at a location overlapping the thermosensitive recording region 2B (thermosensitive recording layer 40), in a plan view. The identification region 2A is disposed, on the support substrate 10, at a location overlapping the thermosensitive recording region 1B (thermosensitive recording layer 40), in a side view.

The thermosensitive recording medium 20 includes, for example, the embedded layer 21 in contact with the surface of the support substrate 10, and the cover layer 22 that is in contact with the surface of the embedded layer 21 and covers the embedded layer 21. The cover layer 22 constitutes the outermost surface of the identification element 2 (thermosensitive recording medium 20). The embedded layer 21 is provided with the through-hole part 21B that is able to embed the thermosensitive recording layer 40, for example. The thermosensitive recording layer 40 is fitted into the through-hole part 21B.

For example, as illustrated in FIG. 27, the thermosensitive recording layer 40 includes, the base material 41, the underlayer 42, the recording layer 43, the intermediate layer 44, the recording layer 45, the intermediate layer 46, and the recording layer 47 in this order. For example, as illustrated in FIG. 27, the outermost surface of the thermosensitive recording layer 40 may be provided with the protective layer 48, or the outermost surface of the thermosensitive recording layer 40 may be the recording layer 47. In the thermosensitive recording layer 40, one or two recording layers of the recording layers 43, 45, and 47 may be omitted, as needed.

A plurality of particles 49 is distributed in at least one layer of the recording layers 43, 45, and 47. It is to be noted that FIG. 27 illustrates a state where the plurality of particles 49 is distributed in each of the recording layers 43, 45, and 47. The particle 49 is configured by a material common to that of the particle 31. Examples of the particle 49 may include retroreflective particles, phosphor particles, birefringent particles, infrared-absorbing particles, and glass beads. A region in which the plurality of particles 49 is distributed, of the thermosensitive recording region 2B (thermosensitive recording layer 40), corresponds to a unique physical feature, and specifically corresponds to a physical feature based on artifact metrics. Accordingly, the region in which the plurality of particles 49 is distributed, of the thermosensitive recording region 2B (thermosensitive recording layer 40), is the identification region 2A.

In the identification element 2, for example, an adhesive layer may be provided between the support substrate 10 and the embedded layer 21 or between the embedded layer 21 and the cover layer 22. The adhesive layer includes a thermal adhesive, for example. The thermal adhesive includes a thermosetting resin, for example. The thermosetting resin includes, for example, at least one selected from the group consisting of an epoxy-based resin, a urethane-based resin, and the like. A curing temperature of the thermal adhesive is preferably within a temperature range of 100° C. or more and 120° C. or less, from the viewpoint of reducing damage to the thermosensitive recording layer 40.

In the same manner as the identification element 1, the identification element 2 may include a laser marking layer. The identification element 2 may include the laser marking layer, for example, in the support substrate 10, between the support substrate 10 and the thermosensitive recording medium 20, or in the thermosensitive recording medium 20. The laser marking layer is disposed in the thermosensitive recording medium 20 or at least at a location opposed to the thermosensitive recording medium 20. It is to be noted that the laser marking layer may be disposed at a location that is non-opposed to the thermosensitive recording medium 20.

### [Method of Manufacturing Identification Element 2]

Next, description is given of an example of a method of manufacturing the identification element 2.

First, a thermosetting resin is applied as a thermal adhesive to one main surface of the support substrate 10 to form an adhesive layer. Next, a thermosetting resin is applied to a surface of the embedded layer 21 into which an undrawn thermosensitive recording layer 40A is fitted in advance, and then the embedded layer 21 is placed on the main surface of the support substrate 10, with a coated film interposed therebetween.

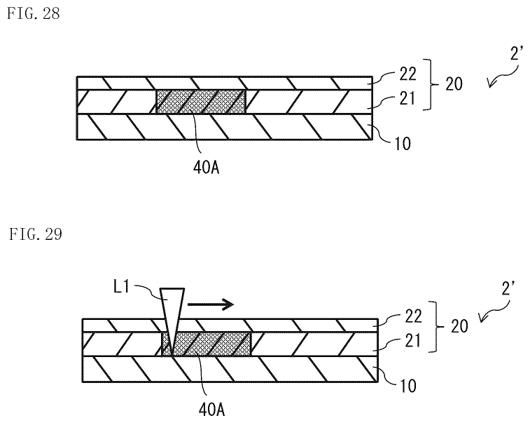

Next, a thermosetting resin is applied as a thermal adhesive on the embedded layer 21 to form an adhesive layer, and then the cover layer 22 is placed on the adhesive layer. Next, a stack thus formed is sandwiched between metal plates and is pressurized while being heated to thereby thermally cure the adhesive layer. A temperature to be applied to the stack upon the thermal curing is preferably 100° C. or more and 120° C. or less, from the viewpoint of reducing damage to the thermosensitive recording layer 40A. It is to be noted that thermal lamination may be performed on the stack formed as described above to thereby thermally cure the adhesive layer. In this manner, for example, an undrawn identification element 2′ as illustrated in FIG. 28 is manufactured.

Next, for example, as illustrated in FIG. 29, the thermosensitive recording layer 40A is irradiated with the laser light L1. This allows for formation of the thermosensitive recording layer 40 with image information on a user being embedded in the thermosensitive recording layer 40A (i.e., with an image being drawn on the thermosensitive recording layer 40A). In this manner, for example, the drawn identification element 2 as illustrated in FIGS. 25 and 26 is manufactured.

It is to be noted that, in the present embodiment, the above-described adhesive layer may be omitted to attach the support substrate 10 and the embedded layer 21 to each other by fusion and to attach the embedded layer 21 and the cover layer 22 to each other by fusion. At this time, for example, a material similar to those in the foregoing embodiment may be used for the support substrate 10, the embedded layer 21, and the cover layer 22.

Next, description is given of an example of a method of manufacturing the undrawn identification element 2′ using fusion. First, the embedded layer 21 into which the undrawn thermosensitive recording layer 40A is fitted in advance is placed on one main surface of the support substrate 10. Next, the cover layer 22 is placed on the embedded layer 21. Next, a stack including the support substrate 10, the embedded layer 21, and the cover layer 22 is sandwiched between metal plates, and is pressurized while being heated, thereby thermally fusing the support substrate 10 and the embedded layer 21 together and thermally fusing the embedded layer 21 and the cover layer 22 together. A temperature to be applied to the stack upon the thermal fusing is preferably 130° C. or more and 200° C. or less, from the viewpoint of reducing damage to the thermosensitive recording layer 40A and from the viewpoint of developing sufficient fusion strength. This enables manufacture of the identification element 2′ by fusion. [Effects]

Next, description is given of effects of the identification element 2 according to the present embodiment.

The identification element 2 according to the present embodiment is provided with the thermosensitive recording medium 20 in which one or a plurality of layers is provided on the support substrate 10, and the identification region 2A having a unique physical feature is provided in at least a portion of the thermosensitive recording medium 20. Here, unlike a two-dimensional bar code, a hologram, or the like, for example, which has a poor anti-counterfeit property and is highly likely to impair the appearance, the identification region 2A has a unique physical feature of a superior anti-counterfeit property and of being unlikely to impair the appearance. In addition, it is possible for the identification region 2A to be formed in a relatively simple manner, as compared with the two-dimensional bar code, the hologram, or the like, for example. It is therefore possible to improve the anti-counterfeit property without impairing the appearance. In addition, it is possible to improve safety of authentication in a simple manner.

In the identification element 2 according to the present embodiment, at least one layer of the one or the plurality of layers included in the thermosensitive recording medium 20 includes the recording layer 43, the recording layer 45, or the recording layer 47. This makes it possible to improve safety of authentication by utilizing the recording layer 43, the recording layer 45, or the recording layer 47.

In the identification element 2 according to the present embodiment, the identification region 2A is disposed at a location, on the support substrate 10, that overlaps one or a plurality of thermosensitive recording layers (at least one layer of the recording layer 43, the recording layer 45, and the recording layer 47), in a plan view. In addition, in the identification element 2 according to the present embodiment, the identification region 2A is disposed at a location, on the support substrate 10, that overlaps the one or the plurality of thermosensitive recording layers (at least one layer of the recording layer 43, the recording layer 45, and the recording layer 47), in a side view. For example, the identification region 2A is a portion of the one or the plurality of thermosensitive recording layers (at least one layer of the recording layer 43, the recording layer 45, and the recording layer 47). In such a case, it is possible to cause the identification region 2A to also serve as the thermosensitive recording region 2B. This makes it possible to improve the anti-counterfeit property without impairing the appearance.

### 4. Modification Examples of Second Embodiment

### Modification Example 2-1

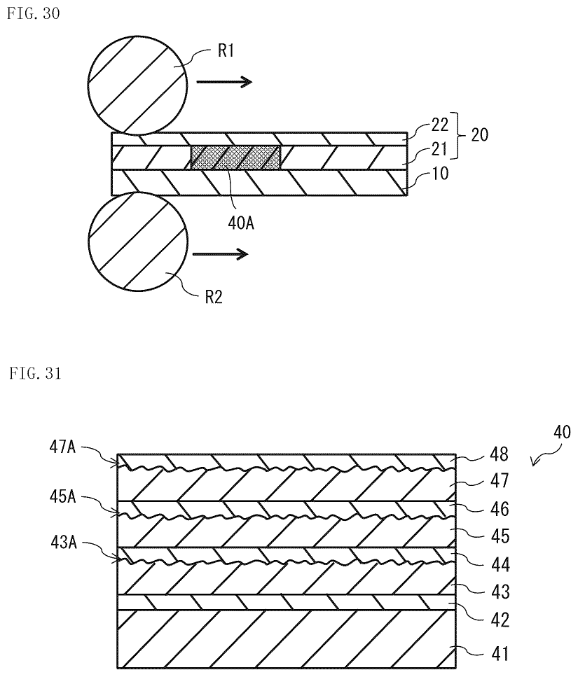

FIG. 30 illustrates a modification example of a method of manufacturing the identification element 2 according to the second embodiment. In the second embodiment, for example, as illustrated in FIG. 30, the stack including the support substrate 10, the embedded layer 21, and the cover layer 22 may be sandwiched between a pair of heated rollers R1 and R2; in such a sandwiching state, the rollers R1 and R2 may be rotated to thermally cure an adhesive in the above-described stack or to thermally fuse the above-described stack, thereby forming the identification element 2′.

In a case where the identification element 2′ is formed in this manner, it is possible to visually recognize a pattern such as non-uniformity of a background in the thermosensitive recording region 2B (the thermosensitive recording layer 40A or the thermosensitive recording layer 40), when viewing the identification element 2′ or the identification element 2 in one of the following three methods:
(1) when viewing the identification element 2′ or the identification element 2 in a plan view;
(2) when viewing the identification element 2′ or the identification element 2 in a direction tilted at a predetermined angle to a traveling direction of the rollers R1 and R2, from the state where the identification element 2′ or the identification element 2 is viewed in a plan view; and
(3) when viewing the identification element 2′ or the identification element 2 in a direction tilted at a predetermined angle to a direction orthogonal to the traveling direction of the rollers R1 and R2, from the state where the identification element 2′ or the identification element 2 is viewed in a plan view.

In the present modification example, the above-described region including a pattern such as non-uniformity of the background corresponds to a unique physical feature, and specifically corresponds to a physical feature based on artifact metrics. Accordingly, the above-described region including a pattern such as non-uniformity of the background corresponds to the identification region 2A. Here, unlike a two-dimensional bar code, a hologram, or the like, for example, which has a poor anti-counterfeit property and is highly likely to impair the appearance, the identification region 2A has a unique physical feature of a superior anti-counterfeit property and of being unlikely to impair the appearance. In addition, it is possible for the identification region 2A to be formed in a relatively simple manner, as compared with the two-dimensional bar code, the hologram, or the like, for example. It is therefore possible to improve the anti-counterfeit property without impairing the appearance. In addition, it is possible to improve safety of authentication in a simple manner.

### Modification Example 2-2

FIG. 31 illustrates a modification example of the cross-sectional configuration of the thermosensitive recording layer 40 included in the identification element 2 according to the second embodiment. In the identification element 2 according to the second embodiment, at least one layer of the recording layer 43, the recording layer 45, and the recording layer 47 may have an uneven surface, as a surface thereof, on a side opposed to a substrate 41, for example, as illustrated in FIG. 31. It is to be noted that FIG. 31 exemplifies a state where uneven surfaces 43A, 45A, and 47A are provided on surfaces of respective layers of the recording layer 43, the recording layer 45, and the recording layer 47. Providing the uneven surface 43A makes it possible to enhance detaching strength between the recording layer 43 and the intermediate layer 43. In addition, providing the uneven surface 45A makes it possible to enhance detaching strength between the recording layer 45 and the intermediate layer 45. In addition, providing the uneven surface 47A makes it possible to enhance the detaching strength between the recording layer 47 and the protective layer 48.

The uneven surfaces 43A, 45A, and 47A are each configured by a random unevenness. The uneven surfaces 43A, 45A, and 47A are uneven surfaces formed on the recording layer 43, the recording layer 45, and the recording layer 47 due to Benard cell. In the present modification example, a region including the uneven surfaces 43A, 45A, and 47A corresponds to a unique physical feature, and specifically corresponds to a physical feature based on artifact metrics. Accordingly, the region including the uneven surfaces 43A, 45A, and 47A corresponds to the identification region 2A. The uneven surfaces 43A, 45A, and 47A each has an unevenness size of 50 μm or more and 100 μm or less, for example. The uneven surfaces 43A, 45A, and 47A each has an unevenness height of 2 μm or more and 3 μm or less, for example.

The unevenness size in the uneven surfaces 43A, 45A, and 47A is determined by one of the following methods (1) to (3).
(1) Uneven shapes of the surfaces of the recording layer 43, the recording layer 45, and the recording layer 47 are subjected to depth combination in a height direction to acquire image data by using a microscope mounted with a high-definition camera. Measuring a length of the acquired uneven shape in a width direction allows the unevenness size to be obtained.
(2) A cross-section is taken by a microtome or the like to measure the unevenness size of each surface of the recording layer 43, the recording layer 45, and the recording layer 47 by using an SEM (Scanning Electron Microscope).
(3) Observing a portion colored into a uniform color tone after drawing using a microscope allows a spot-like image to be obtained. A size of the spot depends on the unevenness of each of the surfaces of the recording layer 43, the recording layer 45, and the recording layer 47; thus, measuring the size of the spot allows the unevenness size to be obtained.

The unevenness height in each of the uneven surfaces 43A, 45A, and 47A is determined by one of the following methods (4) and (5).
(4) Uneven shapes of the surfaces of the recording layer 43, the recording layer 45, and the recording layer 47 are subjected to depth combination in the height direction to acquire image data by using a microscope mounted with a high-definition camera. Measuring a height difference between a peak and a trough of the acquired uneven shape allows the unevenness height to be obtained.
(2) A cross-section is taken by a microtome or the like to measure the unevenness height of each surface of the recording layer 43, the recording layer 45, and the recording layer 47 using an SEM.

In the present modification example, the region including the uneven surfaces 43A, 45A, and 47A formed due to Benard cell corresponds to the identification region 2A. Here, unlike a two-dimensional bar code, a hologram, or the like, for example, which has a poor anti-counterfeit property and is highly likely to impair the appearance, the identification region 2A has a unique physical feature of a superior anti-counterfeit property and of being unlikely to impair the appearance. In addition, it is possible for the identification region 2A to be formed in a relatively simple manner, as compared with the two-dimensional bar code, the hologram, or the like, for example. It is therefore possible to improve the anti-counterfeit property without impairing the appearance. In addition, it is possible to improve safety of authentication in a simple manner.

### Modification Example 2-3

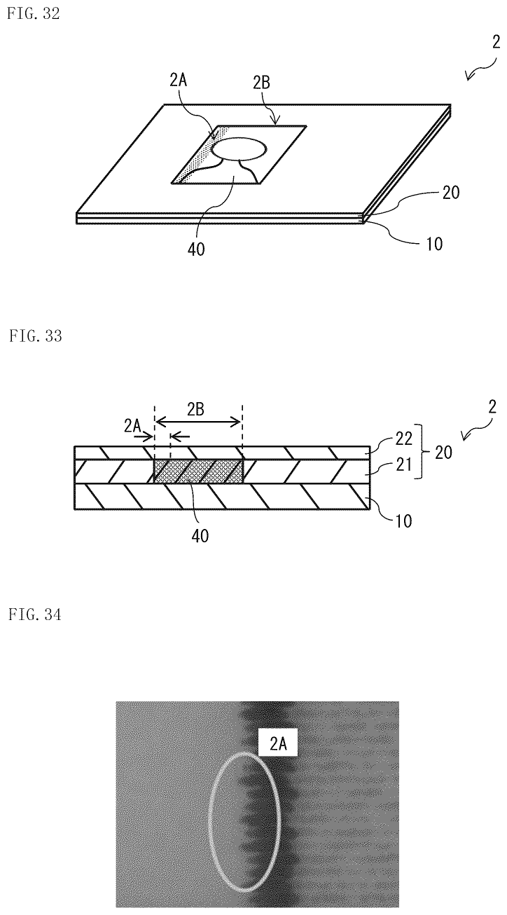

FIG. 32 illustrates a modification example of the perspective configuration of the identification element 2 according to the second embodiment. FIG. 33 illustrates an example of a cross-sectional configuration of the identification element 2 of FIG. 32. In the identification element 2 according to the second embodiment, for example, as illustrated in FIGS. 32 and 33, the identification region 2A may be a region, of the thermosensitive recording region 2B (thermosensitive recording layer 40), including starting points of laser drawing in a plurality of rows. For example, as illustrated in FIG. 34, the starting points of the laser drawing are slightly shifted from one row to another. Accordingly, a profile (a profile of an end edge at a location where thermosensitive coloration is generated) formed by the starting points of the laser drawing in the plurality of rows corresponds to a unique physical feature, and specifically corresponds to a physical feature based on artifact metrics. Accordingly, the profile (profile of the end edge at a location where thermosensitive coloration is generated) formed by the starting points of the laser drawing in the plurality of rows is the identification region 2A.

As described above, in the present modification example, the identification region 2A is a region including the profile of the end edge at the location where the thermosensitive coloration is generated. This enables the identification region 1A to also serve as a drawing mark of the thermosensitive recording region 2B (thermosensitive recording layer 40). This makes it possible to improve the anti-counterfeit property without impairing the appearance.

### Modification Example 2-4

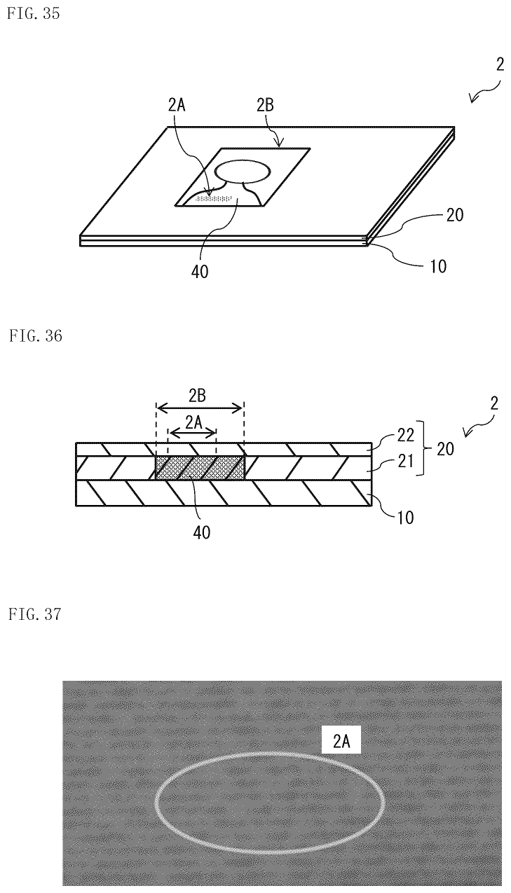

FIG. 35 illustrates a modification example of the perspective configuration of the identification element 2 according to the second embodiment. FIG. 36 illustrates an example of a cross-sectional configuration of the identification element 2 of FIG. 35. In the identification element 2 according to the second embodiment, for example, as illustrated in FIGS. 35 and 36, the identification region 2A may be a region, of the thermosensitive recording region 2B (thermosensitive recording layer 40), including a “drawing mark of a specific region”. The “drawing mark of a specific region” refers to low-gradation drawing mark random dots or a drawing stripe, for example, as illustrated in FIG. 37. A profile (a profile of a drawing mark at a location where thermosensitive coloration is generated) formed by the low-gradation drawing mark random dots or the drawing stripe corresponds to a unique physical feature, and specifically corresponds to a physical feature based on artifact metrics. Accordingly, the profile formed by the low-gradation drawing mark random dots or the drawing stripe is the identification region 2A.

As described above, in the present modification example, the identification region 2A is a region including the profile formed by the low-gradation drawing mark random dots or the drawing stripe. This enables the identification region 1A to also serve as the drawing mark of the thermosensitive recording region 2B (thermosensitive recording layer 40). This makes it possible to improve the anti-counterfeit property without impairing the appearance.

### Modification Example 2-5

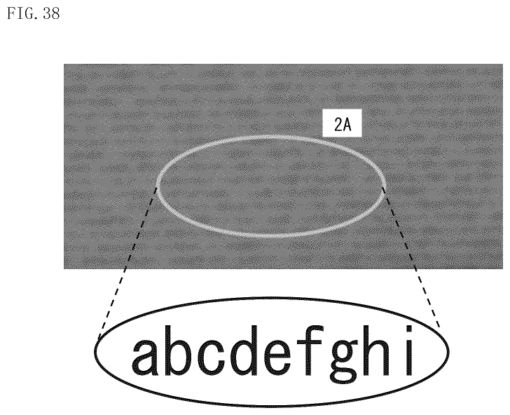

FIG. 38 illustrates, in an enlarged manner, an example of a planar configuration of a portion of the thermosensitive recording layer 40 included in the identification element 2 according to the second embodiment. In the identification element 2 according to the second embodiment, for example, as illustrated in FIG. 38, the identification region 2A may be a region including a string of letters of μm-order size included in a location where thermosensitive coloration is generated. The region including such a string of letters corresponds to a unique physical feature, and specifically corresponds to a physical feature based on artifact metrics. Accordingly, the profile formed by the low-gradation drawing mark random dots or the drawing stripe is the identification region 2A.

As described above, in the present modification example, the identification region 2A is the region including a string of letters of μm-order size included in the location where thermosensitive coloration is generated. This enables the identification region 1A to also serve as the drawing mark of the thermosensitive recording region 2B (thermosensitive recording layer 40). This makes it possible to improve the anti-counterfeit property without impairing the appearance.

### Modification Example 2-6

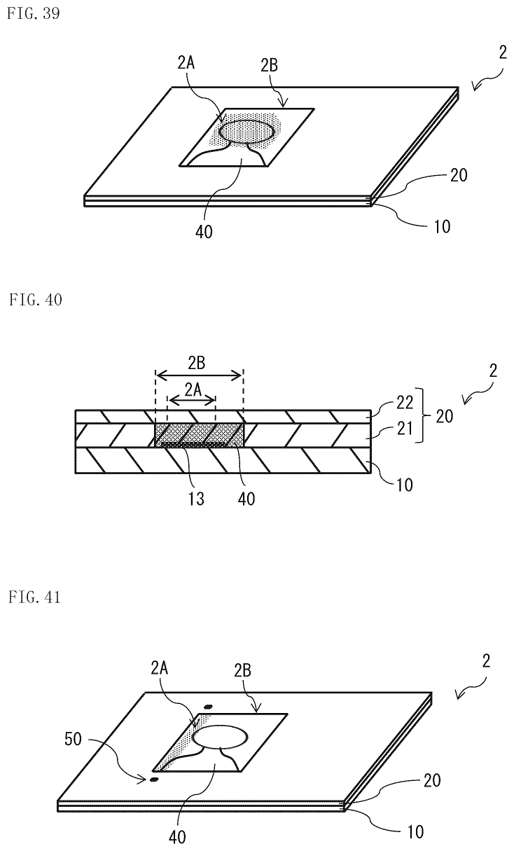

FIG. 39 illustrates a modification example of the perspective configuration of the identification element 2 according to the second embodiment. FIG. 40 illustrates an example of a cross-sectional configuration of the identification element 2 of FIG. 39. The identification element 2 according to the second embodiment may include an underlayer 13, for example, as illustrated in FIGS. 39 and 40. The underlayer 13 is provided between the support substrate 10 and the thermosensitive recording region 2B (thermosensitive recording layer 40), and is in contact with a surface, of the support substrate 10, on a side of the thermosensitive recording region 2B (thermosensitive recording layer 40). The underlayer 13 is, for example, a printed layer formed by printing a pattern (e.g., a design, a graphic, a photograph, a letter, or a combination of two or more thereof) on the surface of the support substrate 10. A pattern visible at the time when the thermosensitive recording region 2B (thermosensitive recording layer 40) is viewed in a plan view corresponds to a unique physical feature, and specifically corresponds to a physical feature based on artifact metrics. Accordingly, the region including a pattern formed by the underlayer 13 is the identification region 2A.

As described above, in the present modification example, the identification region 2A is a region including a pattern formed by the underlayer 13. This enables the identification region 1A to be provided in a region opposed to the thermosensitive recording region 2B (thermosensitive recording layer 40). This makes it possible to improve the anti-counterfeit property without impairing the appearance.

### Modification Example 2-7

FIG. 41 illustrates a modification example of the perspective configuration of the identification element 2 according to the second embodiment. FIG. 42 illustrates an example of a cross-sectional configuration of the identification element 2 of FIG. 41. For example, as illustrated in FIGS. 41 and 42, the identification element 2 according to the second embodiment may further include the positioning mark 50 that is able to specify a position of the identification region 2A. The positioning mark 50 is provided around the identification region 2A, in a plan view.

Here, it is assumed that the identification element 2 is provided with the underlayer 11, for example, as illustrated in FIG. 42. The underlayer 11 is provided between the support substrate 10 and the embedded layer 21 (thermosensitive recording layer 20), and is in contact with a surface, of the support substrate 10, on the side of the embedded layer 21 (thermosensitive recording layer 20). The underlayer 11 is, for example, a printed layer formed by printing a pattern (e.g., a design, a graphic, a photograph, a letter, or a combination of two or more thereof) on the surface of the support substrate 10. At this time, the positioning mark 50 may be, for example, a pattern of the underlayer 11.

As described above, in the present modification example, the positioning mark 50 is provided. This enables, for example, users of the registration apparatus 300, the imaging apparatus 500, and the inquiry apparatus 700 to easily grasp an imaging region (a region including the identification region 2A (identification layer 30)) of the imaging apparatus, with the help of the positioning mark 50. As a result, it is possible to accurately capture an image of the identification region 2A (identification layer 30).

In addition, in the present modification example, in a case where the positioning mark 50 is a pattern of the underlayer 11, the positioning mark 50 is covered with the support substrate 10 and the embedded layer 21. This enables protection of the positioning mark 50, thus making it possible to improve the anti-counterfeit property of the positioning mark 50.

In the present modification example, the underlayer 11 may be a thermosensitive recording layer in which the positioning mark 50 is drawn, for example, as illustrated in FIG. 43. Here, the thermosensitive recording layer constituting the underlayer 11 is configured by, for example, a material common to that of the recording layer 43, the recording layer 45, or the recording layer 47. In such a case, irradiation of the undrawn underlayer 11′ with laser light enables formation of the underlayer 11 with the positioning mark 50 being drawn. At this time, for example, drawing the positioning mark 50 by using a position of the identification region 2A (identification layer 30) as a standard makes it possible to accurately draw the positioning mark 50 with respect to the identification region 2A (identification layer 30).

### Modification Example 2-8

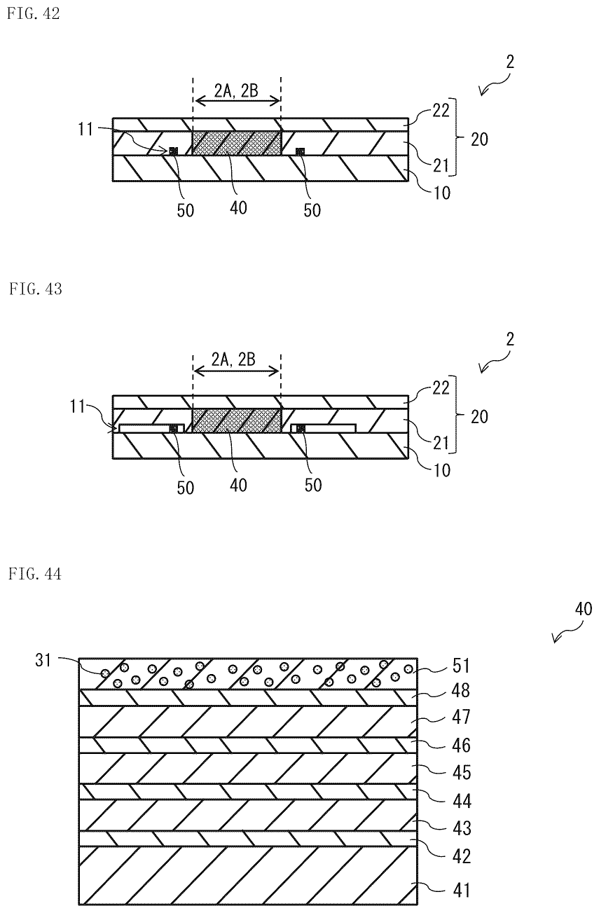

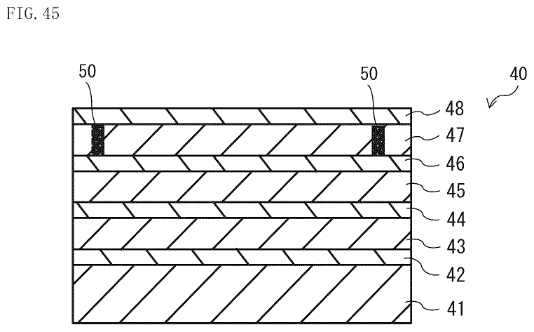

FIG. 44 illustrates a modification example of the cross-sectional configuration of the thermosensitive recording region 2B (thermosensitive recording layer 40) provided in the identification element 2 according to the second embodiment. For example, as illustrated in FIG. 44, the thermosensitive recording region 2B (thermosensitive recording layer 40) may independently include the identification region 2A (an identification layer 51) in the thermosensitive recording region 2B (thermosensitive recording layer 40). The identification layer 51 is configured by a material common to that of the identification layer 30. Also in such a case, for example, drawing the positioning mark 50 by using the position of the identification region 2A (identification layer 30) as a standard makes it possible to accurately draw the positioning mark 50 with respect to the identification region 2A (identification layer 30).

### Modification Example 2-9

FIG. 45 illustrates a modification example of the cross-sectional configuration of the thermosensitive recording region 2B (thermosensitive recording layer 40) provided in the identification element 2 according to the second embodiment. The thermosensitive recording region 2B (thermosensitive recording layer 40) may include the positioning mark 50 in one layer of the recording layer 43, the recording layer 45, and the recording layer 47, for example. The thermosensitive recording region 2B (thermosensitive recording layer 40) may include the positioning mark 50 in the layer of the recording layer 47, for example, as illustrated in FIG. 45. Also in such a case, for example, drawing the positioning mark 50 by using the position of the identification region 2A (identification layer 30) as a standard makes it possible to accurately draw the positioning mark 50 with respect to the identification region 2A (identification layer 30).

It is to be noted that the effects described herein are merely exemplary. The effects of the present disclosure are not limited to the effects described herein. The present disclosure may have effects other than those described herein.

In addition, for example, the present disclosure may have the following configurations.

(1)

An identification element including a thermosensitive recording medium provided with one or a plurality of layers on a support substrate, in which
an identification region having a unique physical feature is provided in at least a portion of the thermosensitive recording medium.
   (2)

The identification element according to (1), in which at least one layer of the one or the plurality of layers includes a thermosensitive recording layer.

(3)

The identification element according to (2), in which the identification region is disposed, on the support substrate, at a location different from one or a plurality of the thermosensitive recording layers, in a plan view.

(4)

The identification element according to (2), in which the identification region is disposed, on the support substrate, at a location overlapping one or a plurality of the thermosensitive recording layers, in a plan view.

(5)

The identification element according to (2), in which the identification region is disposed, on the support substrate, at a location different from one or a plurality of the thermosensitive recording layers, in a side view.

(6)

The identification element according to (2), in which the identification region is disposed, on the support substrate, at a location overlapping one or a plurality of the thermosensitive recording layers, in a side view.

(7)

The identification element according to any one of (2) to (6), in which an outermost layer in the one or the plurality of layers is provided to cover the one or the plurality of the thermosensitive recording layers.

(8)

The identification element according to (7), in which
an embedding structure is provided at a location, of the one or the plurality of layers, other than the outermost layer, the embedding structure being configured to embed the one or the plurality of the thermosensitive recording layers, and
the one or the plurality of the thermosensitive recording layers is embedded in the embedding structure.
   (9)

The identification element according to (8), in which the identification region includes a boundary line between the one or the plurality of the thermosensitive recording layers and the embedding structure, in a plan view.

(10)

The identification element according to any one of (2) to (9), in which the identification region includes a portion of the one or the plurality of the thermosensitive recording layers.

(11)

The identification element according to any one of (1) to (10), in which the identification region includes a region in which retroreflective particles, phosphor particles, birefringent particles, infrared-absorbing particles, ultraviolet-absorbing particles, visible light-absorbing particles, or light-scattering particles are distributed.

(12)

The identification element according to (10), in which the identification region includes an uneven surface formed on the one or the plurality of the thermosensitive recording layers due to Benard cell in a manufacturing process.

(13)

The identification element according to any one of (1) to (12), further including a positioning mark configured to specify a position of the identification region.

(14)

The identification element according to (13), in which the positioning mark is formed by thermosensitive recording.

(15)

The identification element according to (14), further including an underlayer provided between the support substrate and the one or the plurality of the thermosensitive recording layers, the underlayer having a pattern being formed thereon, in which
the positioning mark includes the pattern of the underlayer.
   (16)

The identification element according to (10), in which the one or the plurality of the thermosensitive recording layers is thermosensitively colored.

(17)

The identification element according to (16), in which the identification region includes a profile of an end edge at a location where the thermosensitive coloration is generated, a string of letters of μm-order size included in the location where the thermosensitive coloration is generated, a profile of a drawing mark at the location where the thermosensitive coloration is generated, or a pattern such as non-uniformity of a background.

(18)

An inquiry apparatus including:
a detector configured to detect, as identification information, from an identification region of a recording medium including the identification region having a unique physical feature, information based on the unique physical feature that allows for identification of the recording medium, or feature information corresponding to the information; and
a signal processing unit configured to inquire of a first information processing apparatus about the identification information obtained by the detector, the signal processing unit being configured to acquire a first inquiry result from the first information processing apparatus.
   (19)

The inquiry apparatus according to (18), in which, in a case where the signal processing unit acquires an identifier corresponding to the identification information as the first inquiry result, the signal processing unit is configured to inquire of a second information processing apparatus about the acquired identifier, and is configured to acquire a second inquiry result from the second information processing apparatus.

(20)

The inquiry apparatus according to (19), in which the signal processing unit is configured to acquire, as the second inquiry result, identification information on a user of the recording medium.

(21)

The inquiry apparatus according to (20), further including a display unit that displays the identification information on the user of the recording medium.

(22)

The inquiry apparatus according to (18), in which the signal processing unit is configured to acquire, as the first inquiry result, identification information on a user of the recording medium.

(23)

The inquiry apparatus according to (22), further including a display unit that displays the identification information on the user of the recording medium.

(24)

An inquiry method including:
detecting, from an identification region of a recording medium including the identification region having a unique physical feature, information based on the unique physical feature that allows for identification of the recording medium, or feature information corresponding to the information; and
inquiring of a first information processing apparatus about the information obtained by the detection to acquire a first inquiry result from the first information processing apparatus.

The present application claims the benefit of Japanese Priority Patent Application JP2023-093386 filed with the Japan Patent Office on Jun. 6, 2023, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. An identification element comprising a thermosensitive recording medium provided with one or a plurality of layers on a support substrate, wherein
an identification region having a unique physical feature is provided in at least a portion of the thermosensitive recording medium.

2. The identification element according to claim 1, wherein at least one layer of the one or the plurality of layers includes a thermosensitive recording layer.

3. The identification element according to claim 2, wherein the identification region is disposed, on the support substrate, at a location different from one or a plurality of the thermosensitive recording layers, in a plan view.

4. The identification element according to claim 2, wherein the identification region is disposed, on the support substrate, at a location overlapping one or a plurality of the thermosensitive recording layers, in a plan view.

5. The identification element according to claim 2, wherein the identification region is disposed, on the support substrate, at a location different from one or a plurality of the thermosensitive recording layers, in a side view.

6. The identification element according to claim 2, wherein the identification region is disposed, on the support substrate, at a location overlapping one or a plurality of the thermosensitive recording layers, in a side view.

7. The identification element according to claim 2, wherein an outermost layer in the one or the plurality of layers is provided to cover one or a plurality of the thermosensitive recording layers.

8. The identification element according to claim 7, wherein
an embedding structure is provided at a location, of the one or the plurality of layers, other than the outermost layer, the embedding structure being configured to embed the one or the plurality of the thermosensitive recording layers, and
the one or the plurality of the thermosensitive recording layers is embedded in the embedding structure.

9. The identification element according to claim 8, wherein the identification region comprises a boundary line between the one or the plurality of the thermosensitive recording layers and the embedding structure, in a plan view.

10. The identification element according to claim 2, wherein the identification region comprises a portion of one or a plurality of the thermosensitive recording layers.

11. The identification element according to claim 1, wherein the identification region comprises a region in which retroreflective particles, phosphor particles, birefringent particles, infrared-absorbing particles, ultraviolet-absorbing particles, visible light-absorbing particles, or light-scattering particles are distributed.

12. The identification element according to claim 10, wherein the identification region comprises an uneven surface formed on the one or the plurality of the thermosensitive recording layers due to Benard cell in a manufacturing process.

13. The identification element according to claim 1, further comprising a positioning mark configured to specify a position of the identification region.

14. The identification element according to claim 13, wherein the positioning mark is formed by thermosensitive recording.

15. The identification element according to claim 14, further comprising an underlayer provided between the support substrate and one or a plurality of the thermosensitive recording layers, the underlayer having a pattern being formed thereon, wherein
the positioning mark comprises the pattern of the underlayer.

16. The identification element according to claim 10, wherein the one or the plurality of the thermosensitive recording layers is thermosensitively colored.

17. The identification element according to claim 16, wherein the identification region includes a profile of an end edge at a location where the thermosensitive coloration is generated, a string of letters of μm-order size included in the location where the thermosensitive coloration is generated, a profile of a drawing mark at the location where the thermosensitive coloration is generated, or a pattern such as non-uniformity of a background.

18. An inquiry apparatus comprising:
a detector configured to detect, as identification information, from an identification region of a recording medium including the identification region having a unique physical feature, information based on the unique physical feature that allows for identification of the recording medium, or feature information corresponding to the information; and
a signal processing unit configured to inquire of a first information processing apparatus about the identification information obtained by the detector, the signal processing unit being configured to acquire a first inquiry result from the first information processing apparatus.

19. The inquiry apparatus according to claim 18, wherein, in a case where the signal processing unit acquires an identifier corresponding to the identification information as the first inquiry result, the signal processing unit is configured to inquire of a second information processing apparatus about the acquired identifier, and is configured to acquire a second inquiry result from the second information processing apparatus.

20. The inquiry apparatus according to claim 19, wherein the signal processing unit is configured to acquire, as the second inquiry result, identification information on a user of the recording medium.

21. The inquiry apparatus according to claim 20, further comprising a display unit that displays the identification information on the user of the recording medium.

22. The inquiry apparatus according to claim 18, wherein the signal processing unit is configured to acquire, as the first inquiry result, identification information on a user of the recording medium.

23. The inquiry apparatus according to claim 22, further comprising a display unit that displays the identification information on the user of the recording medium.

24. An inquiry method comprising:
detecting, from an identification region of a recording medium including the identification region having a unique physical feature, information based on the unique physical feature that allows for identification of the recording medium, or feature information corresponding to the information; and
inquiring of a first information processing apparatus about the information obtained by the detection to acquire a first inquiry result from the first information processing apparatus.
